(19) United States
(12) Patent Application Publication
(10) Pub. No.: US 2017/0117639 A1
(43) Pub. Date: Apr. 27, 2017

(54) ELECTRONIC DEVICE

(71) Applicant: Samsung Electronics Co., Ltd, Gyeonggi-do (KR)

(72) Inventors: Hee-Jo Kim, Gyeonggi-do (KR); Jae-Man Kim, Gyeonggi-do (KR)

(21) Appl. No.: 15/336,746

(22) Filed: Oct. 27, 2016

(30) Foreign Application Priority Data
Oct. 27, 2015 (KR) 10-2015-0149394
Oct. 6, 2016 (KR) 10-2016-0129363

(51) Int. Cl. H01R 4/24; H01R 24/62; H01R 13/66; H01R 24/60; H01R 12/71; H01R 13/648

(52) U.S. Cl. CPC H01R 4/2404; H01R 12/716; H01R 13/648; H01R 13/6616; H01R 24/60; H01R 24/62; H01R 2107/00

(57) ABSTRACT

Disclosed are embodiments related to a device connected to a socket provided in an external device. The device includes: a first connector configured to couple to a receptacle of a first external device; a second connector; a plurality of wires each including a first end connected to the first connector and a second end connected to the second connector; and a material that insulates the wires. The first connector includes: a first structure capable of coupling to the receptacle; a non-conductive second structure connected to the first structure; a plurality of contacts, each of which includes a first portion included inside the first structure, and a second portion included inside the second structure; and a circuit structure that connects two of the second portions of the contacts. At least some of wires are disposed to contact with a corresponding one of the contacts without using a solder.

### CROSS-REFERENCE TO RELATED APPLICATION(S) AND CLAIM OF PRIORITY

The present application is related to and claims the priority under 35 U.S.C. §119(a) to Korean Application Serial No. 10-2015-0149394, which was filed in the Korean Intellectual Property Office on Oct. 27, 2015, and Korean Patent Application Serial No. 10-2016-0129363, which was filed in the Korean Intellectual Property Office on Oct. 6, 2016, the entire content of which is hereby incorporated by reference.

### TECHNICAL FIELD

Various embodiments of the present disclosure relate to a connector device used in an external electronic device.

### BACKGROUND

Recently, various electronic devices, such as an MP3 player, a portable multimedia player (PMP), a tablet PC, GALAXY Tab, a smart phone, I-Pad, an electronic book terminal, have been provided to users, and the users may access various contents while carrying such various electronic devices.

In addition, the electronic devices are connected to a computer or an external device via a wire so that a data service for transmitting or receiving data is actively provided. Further, the wire may be electrically connected to a charger that charges the power source of the electronic device via a connector device. More specifically, the connector device may be defined as a USB connector. The connector device is used for charging a wireless terminal or inputting/outputting data. The connector device includes a socket mounted on a wireless terminal and a plug connector to which a wire is connected.

### SUMMARY

A conventional plug connector has a structure in which a connector is drawn out rearward and connected to a wire by being directly soldered thereto. In addition, the plug connector is configured such that when the connector and the wire are connected to each other, the connector can be connected to the wire by soldering using a board as a medium.

To address the above-discussed deficiencies, it is a primary object to provide a connector device that is manufactured as a product neither by using a separate board nor by being directly soldered to connectors (e.g., contact pins) to reduce the number of assembly steps of a product so that productivity can be improved and material costs can be reduced.

In addition, various embodiments of the present disclosure are to provide a connector device in which a plurality of contacts are provided in the shell part such that two or more of the contacts are in contact with each of the connectors such that a connector connected to a connection terminal provided in a socket of an electronic device can be prevented from generating a short circuit with a shell part, thereby preventing the occurrence of an electric short circuit accident and damage to a component.

According to various embodiments of the present disclosure, an electronic device may include: a first connector that is capable of being coupled to a receptacle of a first external electronic device; a second connector; a plurality of conductive wires each including a first end electrically connected to the first connector and a second end electrically connected to the second connector; and a cladding material that insulates the plurality of conductive wires. The first connector may include: a first structure having a shape and a size that are capable of being coupled to the receptacle of the first external electronic device; a second structure that is non-conductive and is connected to the first structure; a plurality of conductive contacts, each of which includes a first portion included inside the first structure, and a second portion included inside the second structure; and a circuit structure that electrically connects two of the second portions of the plurality of conductive contacts to each other through a resistor element having a selected resistance value. At least some of the plurality of conductive wires may be disposed to be in electric contact with a corresponding one of the plurality of conductive contacts without using solder.

According to various embodiments of the present disclosure, a connector device may include: a housing part including a plurality of connectors that are built therein; a shell part coupled to the housing part to enclose the plurality of connectors; a plurality of wires electrically connected to the plurality of connectors; and a cap part coupled to the housing part to electrically connect the plurality of wires and the plurality of connectors to each other. The shell part may be provided with a plurality of contacts, two or more of which are in contact with each of the connectors.

According to various embodiments of the present disclosure, each of the plurality of contacts may be formed as dual contact portions. The dual contact portions may include a first contact portion electrically connected to a side face of each connector, and a second contact portion electrically connected to a contact terminal formed on each connector.

According to various embodiments of the present disclosure, a connector device is configured neither by using a separate board nor by directly soldering connectors (e.g., contact pins) to reduce the number of assembly steps of a product so that productivity can be improved and material costs can be reduced.

In addition, a plurality of contacts are provided in the shell part such that two or more of the contacts are in contact with each of the connectors such that a connector connected to a connection terminal provided in a socket of an electronic device can be prevented from generating a short circuit with a shell part, thereby preventing the occurrence of an electric short circuit accident and damage to a component. Accordingly, it is possible to improve the quality and reliability of the product, and to increase the life span of the product.

Further, by forming a compact board that is built in the housing part, it is possible to miniaturize and slim the connector device such that the product can be designed to be more beautiful.

In addition, by providing one or more connection pins for each connector, it is possible to make the connector be in contact with a plurality of connection terminals of the socket of the electronic device to maintain a current and voltage, thereby improving the operation of the product.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a perspective view of the front face of an electronic device that is provided with a socket according to various embodiments of the present disclosure;

FIG. 2 illustrates a perspective view of the rear face of the electronic device that is provided with the socket according to various embodiments of the present disclosure;

FIG. 3 illustrates a block diagram of a network environment that includes an electronic device according to various embodiments of the present disclosure;

FIG. 4 illustrates an exploded perspective view of a configuration of a connector device according to various embodiments of the present disclosure;

FIG. 5 illustrates a perspective view of the state of a plurality of contacts before coupling among the components of the connector device according to various embodiments of the present disclosure;

FIG. 6 illustrates a perspective view of the state of a plurality of contacts after coupling among the components of the connector device according to various embodiments of the present disclosure;

FIG. 7 illustrates a perspective view of a shell part among the components of the connector device according to various embodiments of the present disclosure;

FIG. 8 illustrates a perspective view of a housing part among the components of the connector device according to various embodiments of the present disclosure;

FIG. 9 illustrates a side view of a connector among the components of the connector device according to various embodiments of the present disclosure;

FIG. 10 illustrates a side sectional view of one contact pin among the components of the connector device according to various embodiments of the present disclosure;

FIG. 11A illustrates a side sectional view of a pair of contact pins among the components of the connector device according to various embodiments of the present disclosure;

FIG. 11B illustrates an enlarged side sectional view of “B” portion in FIG. 11A;

FIG. 12 illustrates a perspective view of a configuration of a connector device, which does not include a board, according to various embodiments of the present disclosure;

FIG. 13 illustrates a perspective view of a coupling state of the connector device, which does not include a board, according to various embodiments of the present disclosure;

FIG. 14 illustrates a perspective view of a state in which a cap part is coupled among the components of the connector device according to various embodiments of the present disclosure;

FIG. 15 illustrates a perspective view of a state in which a shield can is coupled among the components of the connector device according to various embodiments of the present disclosure;

FIG. 16 illustrates an enlarged perspective view of the “A” portion in FIG. 15;

FIG. 17 illustrates an exploded perspective view of a configuration of a connector device according to other various embodiments of the present disclosure;

FIG. 18 illustrates a perspective view of a state in which a board is coupled among the components of the connector device according to various embodiments of the present disclosure;

FIG. 19 illustrates a front view of a state in which a board is coupled among the components of the connector device according to various embodiments of the present disclosure;

FIG. 20A illustrates a plan view of a board among the components of the connector device according to various embodiments of the present disclosure;

FIG. 20B illustrates a side view of the board among the components of the connector device according to various embodiments of the present disclosure;

FIG. 21 illustrates a perspective view of a configuration of a connector device according to other various embodiments of the present disclosure;

FIG. 22 illustrates a side view of a configuration of a connector device according to other various embodiments of the present disclosure;

FIG. 23 illustrates a perspective view of a state in which a board is coupled to a housing part among the components of the connector device according to other various embodiments of the present disclosure;

FIG. 24 illustrates a side view of a state in which a board is coupled to a housing part among the components of the connector device according to other various embodiments of the present disclosure;

FIG. 25 illustrates an exploded perspective view of a configuration of a connector device including a board according to various embodiments of the present disclosure;

FIG. 26 illustrates a perspective view of a shell part among the components of the connector device according to various embodiments of the present disclosure;

FIGS. 27A and 27B illustrate enlarged perspective views of the shell part among the components of the connector device according to various embodiments of the present disclosure;

FIG. 28A illustrates a plan view of a connector and a board among the components of the connector device according to various embodiments of the present disclosure;

FIG. 28B illustrates a plan view of a connector and a board included in the shell part among the components of the connector device according to various embodiments of the present disclosure;

FIG. 28C illustrates a side view of a connector and a board included in the shell part among the components of the connector device according to various embodiments of the present disclosure;

FIG. 29A illustrates a perspective view of a connector among the components of the connector device according to various embodiments of the present disclosure;

FIG. 29B illustrates an enlarged perspective view of a contact pin of a connector among the components of the connector device according to various embodiments of the present disclosure;

FIG. 29C illustrates a perspective view of another embodiment of a connector among the components of the connector device according to various embodiments of the present disclosure;

FIG. 29D illustrates an enlarged perspective view of another embodiment of a contact pin of a connector among the components of the connector device according to various embodiments of the present disclosure;

FIG. 30A illustrates a front view of a socket of an electronic device, which is coupled to the connector device according to various embodiments of the present disclosure;

FIG. 30B illustrates a side view of a socket of an electronic device, which is coupled to the connector device according to various embodiments of the present disclosure;

FIG. 31A illustrates a front view of another embodiment of a socket of an electronic device, which is coupled to the connector device according to various embodiments of the present disclosure;

FIG. 31B illustrates a side view of another embodiment of a socket of an electronic device, which is coupled to the connector device according to various embodiments of the present disclosure;

FIG. 31C illustrates a plan view of another embodiment of a socket of an electronic device, which is coupled to the connector device according to various embodiments of the present disclosure;

FIG. 32 illustrates a block diagram of a detailed configuration of an electronic device according to various embodiments of the present disclosure; and

FIG. 33 illustrates a block diagram of a program module according to various embodiments.

### DETAILED DESCRIPTION

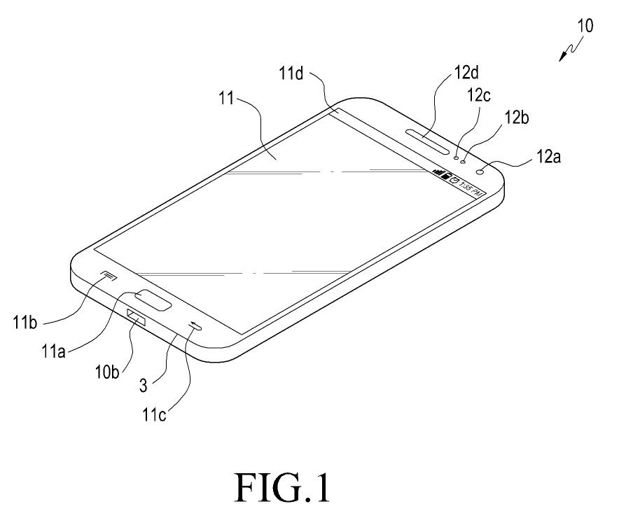

FIGS. 1 through 33, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device.

Hereinafter, various embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements.

As used herein, the expression “have,” “may have,” “include,” or “may include” refers to the existence of a corresponding feature (e.g., numeral, function, operation, or constituent element such as component), and does not exclude one or more additional features.

In the present disclosure, the expression “A or B,” “at least one of A or/and B,” or “one or more of A or/and B” may include all possible combinations of the items listed. For example, the expression “A or B,” “at least one of A and B,” or “at least one of A or B” refers to all of (1) including at least one A, (2) including at least one B, or (3) including all of at least one A and at least one B.

The expression “a first,” “a second,” “the first,” or “the second” used in various embodiments of the present disclosure may modify various components regardless of the order and/or the importance but does not limit the corresponding components. For example, a first user device and a second user device indicate different user devices although both of them are user devices. For example, a first element may be termed a second element, and similarly, a second element may be termed a first element without departing from the scope of the present disclosure.

It should be understood that when an element (e.g., first element) is referred to as being (operatively or communicatively) “connected,” or “coupled,” to another element (e.g., second element), it may be directly connected or coupled directly to the other element or any other element (e.g., third element) may be interposer between them. In contrast, it may be understood that when an element (e.g., first element) is referred to as being “directly connected,” or “directly coupled” to another element (second element), there are no element (e.g., third element) interposed between them.

The expression “configured to” used in the present disclosure may be exchanged with, for example, “suitable for”, “having the capacity to,” “designed to,” “adapted to,” “made to,” or “capable of” according to the situation. The term “configured to” may not necessarily imply “specifically designed to” in hardware. Alternatively, in some situations, the expression “device configured to” may mean that the device, together with other devices or components, “is able to.” For example, the phrase “processor adapted (or configured) to perform A, B, and C” may mean a dedicated processor (e.g., embedded processor) only for performing the corresponding operations or a generic-purpose processor (e.g., central processing unit (CPU) or application processor (AP)) that can perform the corresponding operations by executing one or more software programs stored in a memory device.

The terms used herein are merely for the purpose of describing particular embodiments and are not intended to limit the scope of other embodiments. A singular expression may include a plural expression unless they are definitely different in a context. Unless defined otherwise, all terms used herein, including technical and scientific terms, have the same meaning as those commonly understood by a person skilled in the art to which the present disclosure pertains. Such terms as those defined in a generally used dictionary may be interpreted to have the meanings equal to the contextual meanings in the relevant field of art, and are not to be interpreted to have ideal or excessively formal meanings unless clearly defined in the present disclosure. In some cases, even the term defined in the present disclosure should not be interpreted to exclude embodiments of the present disclosure.

An electronic device according to various embodiments of the present disclosure may include at least one of, for example, a smart phone, a tablet personal computer (PC), a mobile phone, a video phone, an electronic book reader (e-book reader), a desktop PC, a laptop PC, a netbook computer, a workstation, a server, a personal digital assistant (PDA), a portable multimedia payer (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a head-mounted device (HMD)), a fabric or clothing integrated type (e.g., an electronic clothing), a body-mounted type (e.g., a skin pad, or tattoo), and a bio-implantable type (e.g., an implantable circuit).

According to some embodiments, the electronic device may be a home appliance. The home appliance may include at least one of, for example, a television, a digital video disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., SAMSUNG™, APPLE TV™, or GOOGLE TV™), a game console (e.g., XBOX™ and PLAYSTATION™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). In various embodiments, the electronic device may be a combination of one or more of the aforementioned various devices. According to some embodiments, the electronic device may also be a flexible device. Further, the electronic device according to an embodiment of the present disclosure is not limited to the aforementioned devices, and may include a new electronic device according to the development of technology.

Hereinafter, an electronic device according to various embodiments will be described with reference to the accompanying drawings. In the present disclosure, the term “user” may indicate a person using an electronic device or a device (e.g., an artificial intelligence electronic device) using an electronic device.

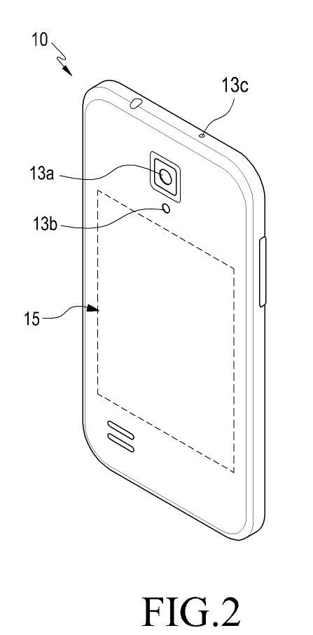

FIG. 1 illustrates a perspective view of the front face of an electronic device. FIG. 2 illustrates a perspective view of the rear face of the electronic device. The electronic device 10 may be a smart phone or a wearable device. Components of an electronic device, such as a smart phone, will be described with reference to FIGS. 1 and 2.

As illustrated in FIG. 1, an electronic device 10 may include a touch screen 11 that is disposed on the center of the front face thereof. The touch screen 11 may occupy a great portion of the front face of the electronic device 10. FIG. 1 illustrates an example in which a main home screen is displayed on the touch screen 11. The main home screen refers to the first screen that is displayed on the touch screen 11 when the power of the electronic device 10 is turned on. When the electronic device 10 has several pages of different home screens, the main home screen may be the first home screen among the several pages of home screens. The home screen may display shortcut icons to execute frequently used applications, a main menu switching key, time, weather, or the like. The main menu switching key may cause a menu screen to be displayed on the touch screen 11. In addition, in the upper end of the touch screen 11, status bars 11d may be formed to indicate the statuses of the device, such as a battery charge status, a received signal strength, and the current time. Below the touch screen 11, a home key 11a, a menu button 11b, and a back button 11c may be formed.

The home key 11a may cause the main home screen to be displayed on the touch screen 11. For example, when the home key 11a is touched in the state where any home screen, which is different from the main home screen, or the menu screen is displayed on the touch screen 11, the main home screen may be displayed on the touch screen 11. In addition, when the home key 11a is touched while applications are being executed on the touch screen 11, the main home screen may be displayed on the touch screen 11. In addition, the home key 11a may be used for causing the most recently used application or a task manager to be displayed on the touch screen 11. The menu button 11b may provide a connection menu that is capable of being used on the touch screen 11. The connection menu may include, for example, a widget addition menu, a background screen change menu, a retrieve menu, an edition menu, or an environment setting menu. The back button 11c may cause the screen, which has been executed just prior to the currently executed screen, to be displayed, or may cause the most recently used application to be terminated.

According to various embodiments, as illustrated in FIG. 1 described above, a first camera 12a, an illuminance sensor 12b, a proximity sensor 12c, or a speaker 12d may be arranged in the upper end area of the front face of the electronic device 10. The electronic device 10 may be provided with a socket 10b that is electrically connected to an external connector device.

As illustrated in FIG. 2, a second camera 13a, a flash 13b, or a speaker 13c may be arranged on the rear face of the electronic device 10. When the electronic device 10 is configured such that a battery pack is detachably mounted thereon, the rear face of the electronic device 10 may be a detachable battery cover 15.

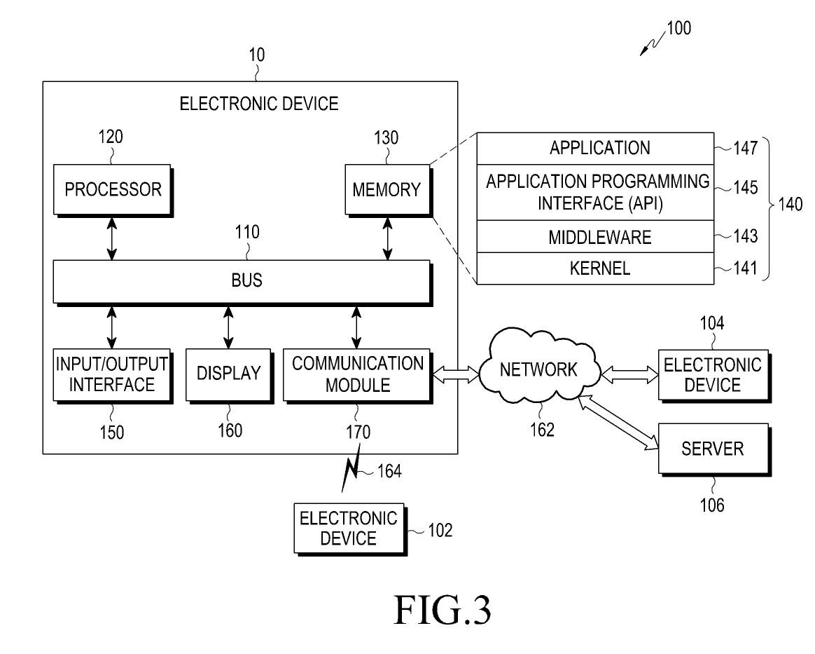

An electronic device 10 within the network environment 100, in various embodiments, will be described with reference to FIG. 3. The electronic device 10 may include a bus 110, a processor 120, a memory 130, an input/output interface 150, a display 160, and a communication interface 170. In a certain embodiment, at least one of the above-mentioned components may be omitted from the electronic device 10 or the electronic device 10 may additionally include other components.

The bus 110 may include, for example, a circuit that connects the above-mentioned components 120 to 170 and transmits communication (e.g., a control message and/or data) between the components.

The processor 120 may include one or more of a central processing unit (CPU), an application processor (AP), and a communication processor (CP). The processor 120 may execute, for example, an arithmetic operation or data processing that is related to a control and/or communication of one or more other components of the electronic device 10.

The memory 130 may include a volatile memory and/or a non-volatile memory. The memory 130 may store, for example, commands or data that are related to one or more other components of the electronic device 10. According to one embodiment, the memory 130 may store software and/or a program 140. The program 140 may include, for example, a kernel 141, a middleware 143, an application programming interface (API) 145, and/or an application program (or an “application”) 147. At least one of the kernel 141, the middleware 143, and the API 145 may be referred to as an operating system (OS).

The kernel 141 may control or manage, for example, system resources (e.g., the bus 110, the processor 120, or the memory 130) that are used for executing operations or functions implemented in the other programs (e.g., the middleware 143, the API 145, or the application programs 147). In addition, the kernel 141 may provide an interface that allows the middleware 143, the API 145, or the application programs 147 to access individual components of the electronic device 10 so as to control or manage the system resources.

The middleware 143 may play an intermediary role such that, for example, the API 145 or the application programs 147 may communicate with the kernel 141 so as to exchange data.

In addition, the middleware 143 may process one or more task requests that are received from the application programs 147, according to priority. For example, the middleware 143 may assign the priority to be capable of using a system resource of the electronic device 10 (e.g., the bus 110, the processor 120, or the memory 130) to at least one of the application programs 147. For example, the middleware 143 may perform scheduling, load balancing, or the like for the one or more task requests by processing the one or more requests according to the assigned priority.

The API 145 is, for example, an interface that allows the applications 147 to control functions provided from the kernel 141 or the middleware 143, and may include, for example, one or more interfaces or functions (e.g., commands) for a file control, a window control, an image processing, or a character control.

The input/output interface 150 may serve as an interface to transmit commands or data, which are entered from, for example, a user or any other external device, to the other component(s) of the electronic device 10. Also, the input/output interface 150 may output commands or data, which are received from the other component(s) of the electronic device 10, to the user or the other external device.

The display 160 may include, for example, a liquid crystal display (LCD), a light emitting diode (LED) display, an organic light emitting diode (OLED) display, or a microelectromechanical systems (MEMS) display, or an electronic paper display. The display 160 may display various contents (e.g., text, image, video, icon, or symbol) to, for example, the user. The display 160 may include a touch screen, and may receive a touch input, a gesture input, a proximity input, or a hovering input that is made using, for example, an electronic pen or a part of the user's body.

The communication interface 170 may set, for example, communication between the electronic device 10 and an external device (e.g., a first external electronic device 102, a second external device 104, or a server 106). For example, the communication interface 170 may communicate with the external device (e.g., the second external electronic device 104 or the server 106) by being connected with a network 162 through wired or wireless communication.

The wireless communication may use at least one of, for example, long-term evolution (LTE), LTE advance (LTE-A), code division multiple access (CDMA), wideband CDMA (WCDMA), universal mobile telecommunication system (UMTS), wireless broadband (WiBro), or global system for mobile communication (GSM), as a cellular communication protocol. In addition, the wireless communication may include, for example, short range communication 164. The short range communication 164 may include at least one of, for example, wireless fidelity (WiFi), BLUETOOTH, near field communication (NFC), and global navigation satellite system (GNSS). GNSS may include, for example, at least one of global positioning system (GPS), global navigation satellite system (Glonass), BEIDOU navigation satellite system (hereinafter, “Beidou”), GALILEO, and the European global satellite-based navigation system, according to, for example, a use area or band width. Herein, “GPS” may be interchangeably used with “GNSS” below. The wired communication may use at least one of, for example, universal serial bus (USB), high definition multimedia interface (HDMI), recommended standard 232 (RS-232), and plain old telephone service (POTS). The network 162 may include a telecommunication network (e.g., at least one of a computer network (e.g., LAN or WAN), the internet, and a telephone network).

Each of the first and second external electronic devices 102 and 104 may be the same type as or different from the electronic device 10. According to one embodiment, the server 106 may include a group of one or more servers. According to various embodiments, all or some of the operations to be executed by the electronic device 10 may be executed in another electronic device or a plurality of other electronic devices (e.g., the electronic devices 102 and 104 or the server 106). According to one embodiment, in the case where the electronic device 10 should perform a certain function or service automatically or by a request, the electronic device 10 may request some functions or services that are associated therewith from the other electronic devices (e.g., the electronic devices 102 and 104 or the server 106), instead of, or in addition to, executing the functions or service by itself. The other electronic devices (e.g., the electronic devices 102 and 104 or the server 106) may execute the requested functions or additional functions, and may transmit the results to the electronic device 10. The electronic device 10 may provide the requested functions or services by processing the received results as they are or additionally. For this purpose, for example, a cloud computing technique, a distributed computing technique, or a client-server computing technique may be used.

The electronic device 10 to be described below may be formed of any one of the above-mentioned wearable device, a notebook computer, a notebook computer, a smart phone, a tablet PC, GALAXY Tab, I-PAD, a wireless charging device, and a connector device. In the present embodiment, the electronic device 10 may be formed as a smart phone.

A bezel area in the electronic device may be minimized to luxuriously implement the design while somewhat increasing the display unit of the electronic device, or to provide a flexible display unit, or to implement a convex or concave display unit.

For example, a peripheral portion of the display unit may be bent, and a screen area may be provided to be used in a state where the screen area is enlarged to a side face portion of the display unit. As the screen area of the display unit is bent and provided to the side face portion thereof, it is possible to use the screen area in an enlarged state, or to use a separate screen on the side face portion, and it is also possible to luxuriously implement the design. According to one embodiment, the display unit may include a first screen area, and second screen areas provided on the opposite sides of the first screen area.

The external electronic device 10 to be described below is configured to include a battery pack built therein, and the battery pack is supplied with power to be charged by being electrically connected to an external charger (not illustrated). At this time, the electronic device including the battery pack and the charger are electrically connected to each other by a connector device so as to supply the power to the battery pack. The connector device may be used for charging power and inputting and outputting various data. The connector device may be electrically connected with a socket 10b (see FIG. 1) provided in the external electronic device 10. In addition, the connector device may be formed as an electronic device. For example, the electronic device may be variously applied as long as it is capable of implementing an electrical connection. For example, the electronic device may be formed as any one of a connector device, a connection terminal, and a socket. In the various embodiments of the present disclosure, a connector device will be described by way of an example.

In the following, descriptions will be made with reference to a configuration of a male connector device 200 that is electrically coupled to the socket 10b of the external electronic device 10 according to various embodiments of the present disclosure.

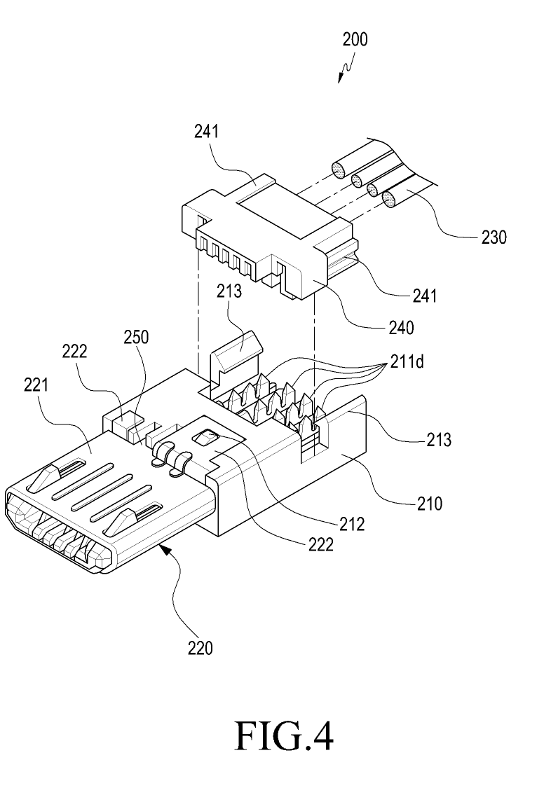

FIG. 4 illustrates an exploded perspective view of a configuration of a connector device 200 included in an electronic device according to various embodiments of the present disclosure.

Referring to FIG. 4, the connector device 200 may include, for example, a housing part 210 having a plurality of connectors 211 built therein, a shell part 220, a plurality of wires 230, and a cap part 240.

The shell part 220 to be described later may be coupled to one face of the housing part 210, and the cap part 240 to be described later may be coupled to the side faces of the housing part 210.

A fastening portion 212 is formed on the one face of the housing part 210 to be coupled with a coupling portion 222 formed on the shell part 220.

Because a pair of hook portions 213 are provided on the side faces of the housing part 210 to be coupled to a pair of binding protrusions 241 formed on the cap part 240, the pair of binding protrusions 241 of the cap part 240 may be fitted and coupled to the pair of hook portions 213 when the cap part 240 is coupled to the upper portion of the housing part 210.

The shell part 220 is coupled to the housing part 210 so as to enclose as well as protect the connectors 211.

The plurality of wires 230 may be coupled to the cap part 240 to be electrically connected with the connectors 211.

The cap part 240 may be coupled to the housing part 210 so as to electrically connect the plurality of wires 230 and the connectors 211 to each other.

In this way, the shell part 220 may be provided with a plurality of contacts 250 to be in contact with two or more of the connectors 211. Due to this, in a state where connection terminals (not illustrated) provided in the socket 10b of the electronic device 10 is in contact with the connectors 211, it is possible to prevent a short circuit generated between the connector 211 and the shell part 220 by an inner voltage, thereby preventing the occurrence of an electric short circuit accident of a product and damage to a component.

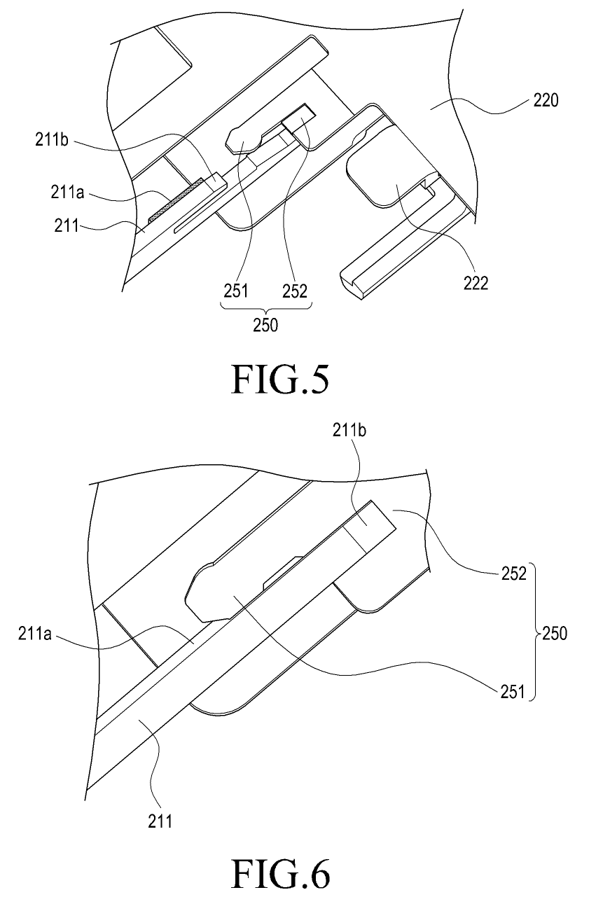

According to one embodiment, the configuration of the plurality of contacts 250 will be described in more detail. FIG. 5 illustrates a perspective view of the state of a plurality of contacts 250 before coupling among the components of the connector device according to various embodiments of the present disclosure. FIG. 6 illustrates a perspective view of the coupling state of the plurality of contacts 250 among the components of the connector device according to various embodiments of the present disclosure.

As illustrated in FIGS. 5 and 6, each of the plurality of contacts 250 may be formed as dual contact portions.

The dual contact portions may be formed of first and second contact portions, in which the first contact portion 251 may be electrically connected to a side face 211a of a connector 211, and the second contact portion 252 may be electrically connected to a contact terminal 211b formed on the connector 211.

For example, as illustrated in FIGS. 5 and 6, the connectors 211 may be coupled by being built in the housing part 210, and may be in contact with the plurality of contacts 250, respectively. In that event, the side face of each connector 211 is connected to the first contact portion 251, and at the same time, the contact terminal 211b of the connector 211 is electrically connected to the second contact portion 252.

Here, the first contact portion 251 may be formed in a semi-spherical shape. The shape of the first contact portion 251 is not limited to the semi-spherical shape. For example, any shape may be applied to the first contact portion 251 as long as the shape facilitates the connection of the first contact portion 251 to the connector 211. For example, the first contact portion 251 may be formed in any one of an oval shape, a circular shape, and a square shape.

Each of the plurality of contacts 250 may be formed in a “U” shape. Each of the plurality of contacts 250 may also be formed in a shape other than the “U” shape.

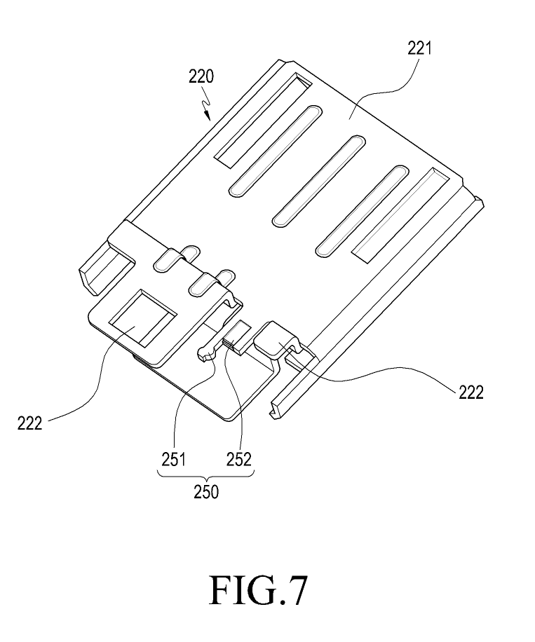

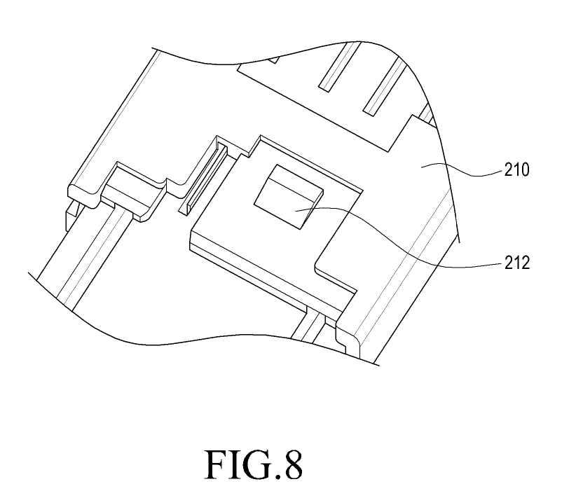

A configuration of the shell part 220 according to one embodiment will be described in more detail. First, FIG. 7 illustrates a perspective view of a shell part 220 among the components of the connector device according to various embodiments of the present disclosure, and FIG. 8 illustrates a perspective view of a housing part 210 among the components of the connector device according to various embodiments of the present disclosure.

As illustrated in FIGS. 7 and 8, a first end of the shell part 220 may be provided with an insertion portion 221 to be inserted into the socket 10b of the electronic device 10. A second end of the shell part 220, which is opposite to the first end, may be provided with a coupling portion 222 to be coupled with a fastening portion 212 that is provided on the one face of the housing part 210.

For example, when the shell part 220 is coupled to the housing part 210, the coupling portion 222 of the shell part 220 may be fixedly hooked to the fastening portion 212 of the housing part 210 simultaneously when the coupling portion 222 of the shell part 220 is inserted into the fastening portion 212. In that event, the connectors 211 built in the housing part 210 are electrically connected to the plurality of contacts 250 of the shell part 220. Because the housing part 210 is formed with through-holes through which the connectors 211 are coupled, respectively, the connectors 211 are electrically connected to the plurality of contacts 250 of the shell part 220 simultaneously when being coupled through the through-holes, respectively.

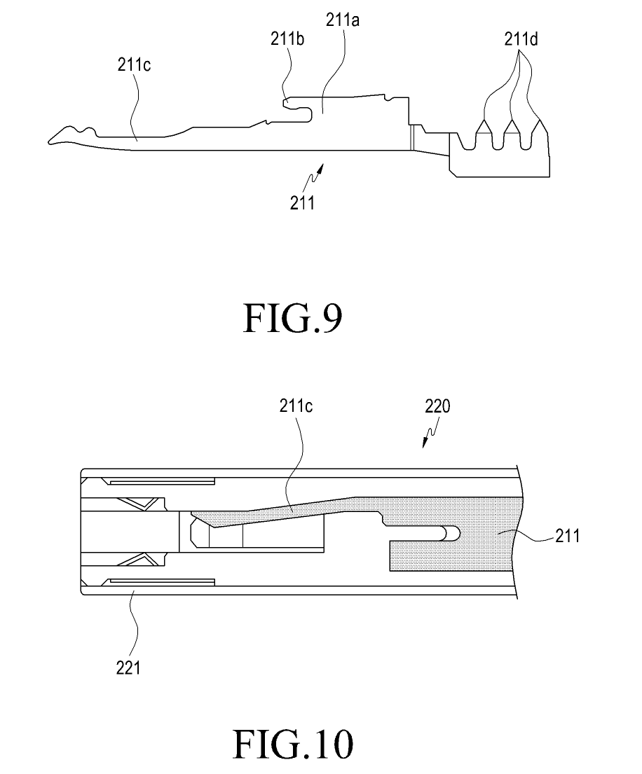

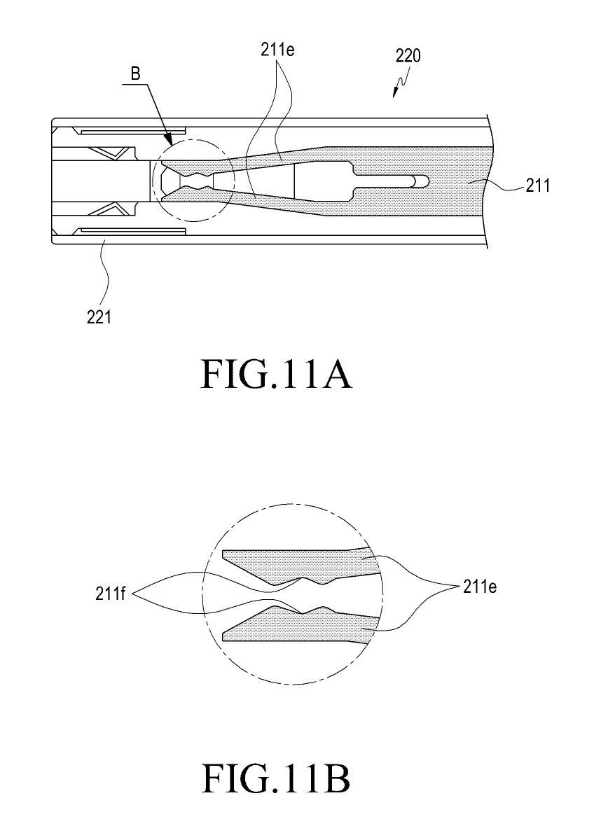

A configuration of a connector 211 according to one embodiment will be described in more detail. FIG. 9 illustrates a perspective view of a connector 211 among the components of the connector device according to various embodiments of the present disclosure, FIG. 10 illustrates a side sectional view of a contact pin among the components of the connector device according to various embodiments of the present disclosure, and FIG. 11 illustrates a side sectional view of a pair of contact pins among the components of the connector device according to various embodiments of the present disclosure.

As illustrated in FIGS. 9 and 10, each of the plurality of connectors 211 may include one connection pin 211c to be electrically connected to the socket 10b of the electronic device 10. For example, a first end of the connector 211 is provided with one connection pin 211c, and the central portion of the connector 211 may be provided with a contact terminal 211b to be electrically connected to the second contact portion 252 of each contact 250. Further, a second end of the connector 211, which is opposite to the first end, may be provided with wire terminals 211d that are connected by covering the plurality of wires 230 when coming in contact with the plurality of wires 230.

As illustrated in FIG. 11A, each connector 211 may include a pair of connection pins 211e to be electrically connected to the socket 10b of the electronic device 10. For example, when the terminal of the socket 10b is inserted between the pair of connection pins 211e to be electrically connected thereto, the connector 211 is in contact with the terminal of the socket 10b by the two connection pins 211e such that the pair of connection pins 211e is capable of facilitating the movement of a current between the connector 211 and the socket 10b and is capable of maintaining a voltage between the connector 211 and the socket 10b. As illustrated in FIG. 11B, the pair of connection pins 211e may be formed with a contact recess 211f to come in easy contact with the terminals of the socket 10b.

According to one embodiment, as illustrated in FIG. 4 described above, the connector device 200 may include a housing part 210 having a plurality of connectors 211 built therein, a shell part 220, a plurality of wires 230, and a cap part 240. The coupling portion 222 of the shell part 220 is fixedly coupled to the fastening portion 212 formed on one face of the housing part 210. Here, each of the plurality of contacts 250 of the shell part 220 is electrically connected to one of the connectors 211 that are built in the housing part 210. For example, the first contact portion 251 of each contact 250 is electrically connected to a side face 211a of a connector 211, and the second contact portion 252 of the contact 250 is electrically connected to a contact terminal 211b formed on the connector 211.

Accordingly, upon being coupled to the housing part 210, the shell part 220 is dually connected to the connector 211 built in the housing part 210 by the first and second contact portions 251 and 252.

In this state, the plurality of wires 230 are coupled to the cap part 250, and the cap part 240 is coupled to the top face of the housing part 210. When the cap part 240 is strongly pushed to the housing part 210 side, the pair of binding protrusions 241 formed on the cap part 240 are fixedly hooked to the pair of hook portions 213 formed on the top face of the housing part 210. In that event, the plurality of wires 230 coupled to the cap part 240 are in contact with the connectors 211 built in the housing part 210, and the plurality of wires 230 are in contact with the wire terminals 211d provided in the connectors 211 and are covered with the wire terminals 211d such that the plurality of wires 230 and the connectors 211 are electrically connected to each other. For example, the wire terminals 211d penetrate the plurality of wires 230, thereby connecting the plurality of wires 230 to the connectors 211. The wire terminals 211d are each formed in a triangular plate shape to easily cover the plurality of wires 230. According to one embodiment, when the cap part 240 with the plurality of wires 230 coupled thereto are pressed, the plurality of wires 230 are lowered such that the wire terminals 211d of the connectors 211 cover and penetrate the plurality of wires 230 to be coupled thereto, and at the same time, electrically connect the connectors 211 and the plurality of wires 230. Thereby, the assembly of the connector device 200 is completed.

In this state, the connectors 211 are inserted into the socket 10b of the electronic device 10 to be electrically connected thereto, and the electronic device 10 may be charged and may input and output data through the connectors 211.

In this way, because the connectors 211 and the socket 10b of the electronic device 10 are electrically connected to each other, and a short circuit, which may be generated between the connectors 211 and the shell part 220 by an inner voltage, is prevented by the plurality of contacts, it is possible to prevent a safety accident (e.g., a fire caused by the electric short circuit) and at the same time, to prevent a component of the electronic device 10 from being damaged.

According to one embodiment, as described above with reference to FIGS. 4 and 5, the connector device 200 may include, for example, a first connector 220 that is capable of being coupled to a receptacle (not illustrated) of the first external device 10, a second connector 240, a plurality of conductive wires 230 each including a first end electrically connected to the first connector 220 and a second end electrically connected to the second connector 240, and a cladding material.

The first connector 220 may include: a first structure 221 having a shape and a size that are capable of being coupled to the receptacle (not illustrated) of the first external electronic device (10); a second structure 210 that is non-conductive and is connected to the first structure; a plurality of conductive connectors 211 each including a first end portion included within the first structure and a second portion included within the second structure; and a circuit structure (not illustrated) that electrically connects two of the second portions of the plurality of conductive contacts to each other through a resistor element (not illustrated) having a selected resistance value. At least some of the plurality of conductive wires 230 may be disposed to be in electric contact with a corresponding one of the plurality of conductive connectors 211 without using soldering.

The first connector 220 may include a shell part, and the second connector 240 may include a cap part. The first structure 221 may include the above-mentioned insertion part, and the second structure 210 may include the above-mentioned housing part 210.

According to one embodiment, the second structure 210 may include a space connected to the two of the second portions of the plurality of conductive connectors 211, and the circuit structure may be disposed within the space and may include an insulation material that is different from the second structure.

According to various embodiments of the present disclosure, as illustrated in FIG. 4 described above, a connector device may include: a housing part including a plurality of connectors that are built therein; a shell part coupled to the housing part to enclose the plurality of connectors; a plurality of wires electrically connected to the plurality of connectors; and a cap part coupled to the housing part to electrically connect the plurality of wires and the plurality of connectors to each other. The shell part may be provided with a plurality of contacts, two or more of which are in contact with each of the connectors.

According to various embodiments of the present disclosure, each of the plurality of contacts is formed as dual contact portions. The dual contact portions may include a first contact portion electrically connected to a side face of each connector, and a second contact portion electrically connected to a contact terminal formed on each connector.

According to various embodiments of the present disclosure, the first contact portion may be formed in a semi-spherical shape.

According to various embodiments of the present disclosure, each of the plurality of contacts may be formed in a “U” shape.

According to various embodiments of the present disclosure, a first end of the shell part is provided with an insertion portion inserted into a socket of the electronic device, and a second end of the shell part, which is opposite to the first end, is provided with a coupling portion to be coupled to a fastening portion provided on the housing part.

According to various embodiments of the present disclosure, each of the plurality of connectors may include one connection pin to be electrically connected to the socket of the electronic device.

According to various embodiments of the present disclosure, each of the plurality of connectors may include a pair of connection pins to be electrically connected to the socket of the electronic device.

In the following, descriptions will be made with reference to a configuration of a male connector device 300 that is electrically coupled to the socket 10b of the external electronic device 10 according to various embodiments of the present disclosure.

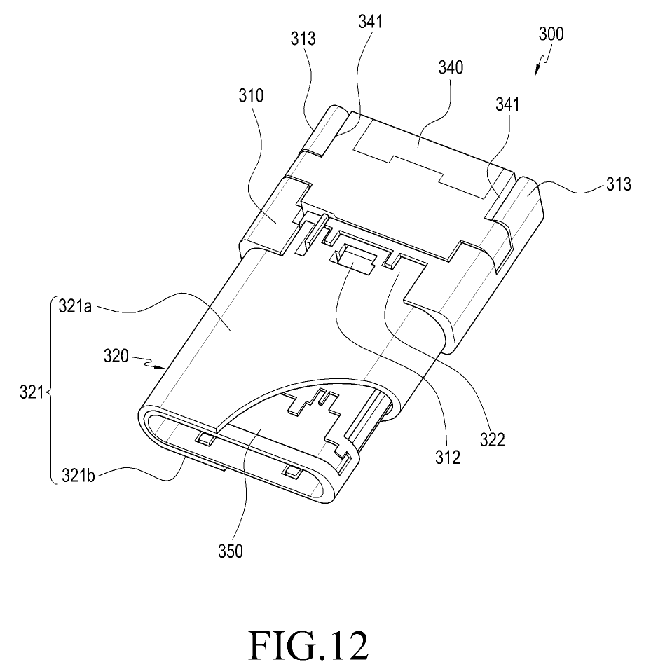

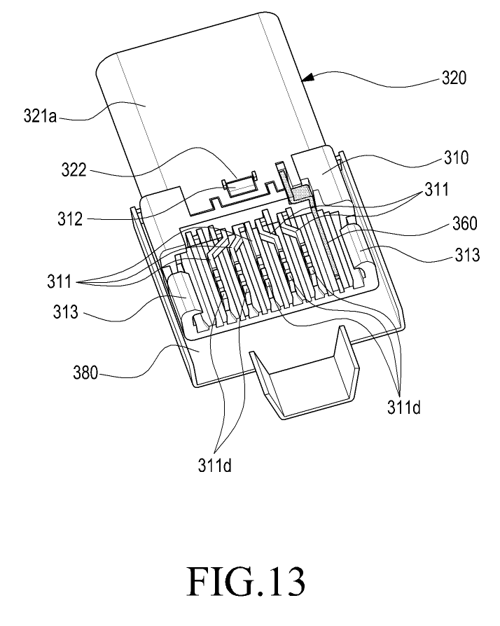

FIG. 12 illustrates an exploded perspective view of a configuration of a connector device included in an electronic device according to other various embodiments of the present disclosure. FIG. 13 illustrates a perspective view of the coupling state of a connector device 300 according to various embodiments of the present disclosure.

Referring to FIGS. 12 and 13, the connector device 300 may include, for example, a housing part 310 having a plurality of connectors 311 built therein, a shell part 320, a plurality of wires (not illustrated), and a cap part (not illustrated).

The shell part 320 to be described later may be coupled to one face of the housing part 310, and the cap part (not illustrated) to be described later may be coupled to the side faces of the housing part 310.

A fastening portion 312 may be formed on the one face of the housing part 310 to be coupled with a coupling portion 322 formed on the shell part 320.

Because a pair of hook portions 313 are provided on the side faces of the housing part 310 to be coupled to a pair of binding protrusions (not illustrated) formed on the cap part (not illustrated), the pair of binding protrusions (not illustrated) of the cap part (not illustrated) may be fitted and coupled to the pair of hook portions 313 when the cap part (not illustrated) is coupled to the upper portion of the housing part 310.

The shell part 320 is coupled to the housing part 310 so as to enclose as well as protect the connectors 311.

The plurality of wires (not illustrated) may be coupled to the cap part (not illustrated) to be electrically connected with the connectors 311.

The cap part (not illustrated) may be coupled to the housing part 310 so as to electrically connect the plurality of wires (not illustrated) and the connectors 311 to each other.

In this way, because the housing part 310 is coupled to the cap part (not illustrated) without a separate board, and the plurality of wires (not illustrated) and the connectors 311 are electrically connected to each other by being pushed without the board, it is possible to improve the electric connection between the plurality of wires (not illustrated) and the connectors 311. In addition, because no separate board is needed to reduce the number of components, it is possible to reduce the assembly process time of a product and to reduce the material costs of the product. For example, because it is not necessary to perform soldering using an existing separate board, the assembly process time and material costs can be reduced so that a product can be manufactured at a low cost.

According to one embodiment, as illustrated in FIG. 12 described above, the shell part 320 may be provided with a ground plate 350. For example, the plurality of connectors 311 may be provided with a ground terminal 360 such that the ground plate 350 and the plurality of wires (not illustrated) can be electrically connected to each other. For example, as illustrated in FIG. 13, because the housing part 310 includes the plurality of connectors 311 and the ground terminal 360 is separately provided at a position neighboring the plurality of connectors 311, the electric connection between the wires (not illustrated) and the connectors 311 can be further facilitated.

A configuration of the shell part 320 according to one embodiment will be described in more detail.

As illustrated in FIGS. 12 and 13 described above, a first end of the shell part 320 may be provided with an insertion portion 321 to be inserted into the socket 10b of the electronic device 10. A second end of the shell part 320, which is opposite to the first end, may be provided with a coupling portion 322 to be coupled with a fastening portion 312 that is provided on the one face of the housing part 310.

For example, when the shell part 320 is coupled to the housing part 310, the coupling portion 322 of the shell part 320 may be fixedly hooked to the fastening portion 312 of the housing part 310 simultaneously when being inserted into the fastening portion 312.

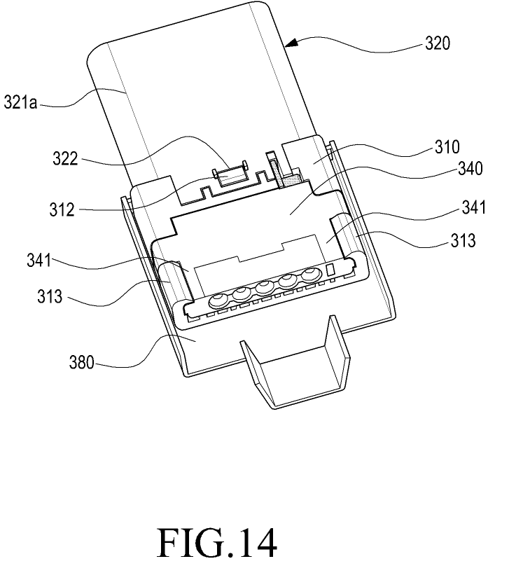

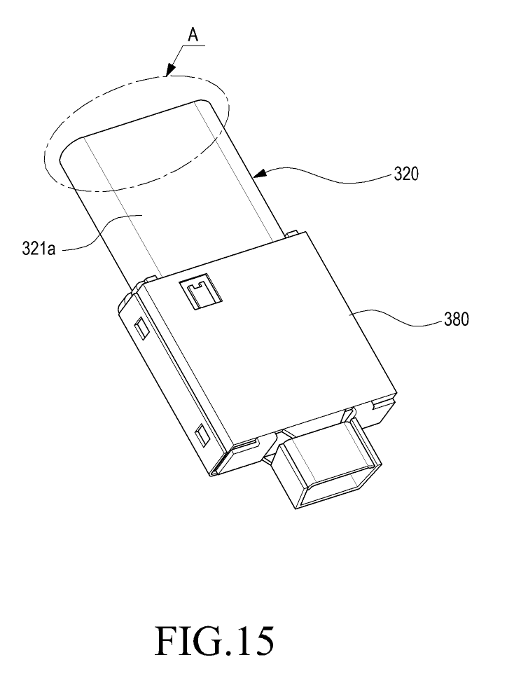

In addition, as in FIG. 14, the cap part (not illustrated) is coupled to the housing part 310. Further, as in FIG. 15, a shield can 380 may be provided outside the housing part 310 so as to electrically shield the housing from the outside.

According to one embodiment, as illustrated in FIG. 12 described above, the connector device 300 may include a housing part 310 having a plurality of connectors 311 built therein, a shell part 320, a plurality of wires (not illustrated), and a cap part (not illustrated). The coupling portion 322 of the shell part 320 is fixedly coupled to the fastening portion 312 formed on one face of the housing part 310. Here, the housing part 310 is separately provided with a ground terminal 360 that is electrically connected to the ground plate 350 that is built in the shell part 320 such that when the housing part 310 is coupled to the shell part 320, the ground terminal 360 is electrically connected to the ground plate 350. In this state, the plurality of wires (not illustrated) are coupled to the cap part (not illustrated), and the cap part (not illustrated) is coupled to the top face of the housing part 310. When the cap part (not illustrated) is strongly pushed to the housing part 310 side, the pair of binding protrusions formed on the cap part (not illustrated) are fixedly hooked to the pair of hook portions formed on the top face of the housing part 310. In that event, the plurality of wires (not illustrated) coupled to the cap part (not illustrated) are in contact with the connectors 311 built in the housing part 310, and the plurality of wires (not illustrated) are in contact with the wire terminals 311d provided in the connectors 311 and at the same time, are covered with the wire terminals 311d such that the plurality of wires (not illustrated) and the connectors 311 are electrically connected to each other. For example, the wire terminals 311d penetrate the plurality of wires (not illustrated), thereby connecting the plurality of wires to the connectors. The wire terminals 311d are each formed in a triangular plate shape to easily cover the plurality of wires (not illustrated). According to one embodiment, when the cap part (not illustrated) with the plurality of wires (not illustrated) coupled thereto are pressed, the plurality of wires (not illustrated) are lowered such that the wire terminals 311d of the connectors 311 cover and penetrate the plurality of wires (not illustrated) to be coupled thereto, and at the same time, electrically connect the connectors 311 and the plurality of wires (not illustrated). As such, the assembly of the connector device 300 is completed. In addition, a separately provided ground wire (not illustrated) is electrically connected to the ground terminal 360.

In this state, the connectors 311 are inserted into the socket 10b of the electronic device 10 to be electrically connected thereto, and the electronic device 10 may be charged and may input and output data through the connectors 311.

In this way, because the separately provided ground terminal 360 prevents a short circuit, which may be generated between the connectors 311 and the shell part 320 by an inner voltage, it is possible to prevent a safety accident (e.g., a fire caused by the electric short circuit) and at the same time, to prevent a component of the electronic device 10 from being damaged.

In addition, because no separate board is needed within the housing 310 so that the number of components is reduced, it is possible to reduce the assembly process time of a product and to reduce material costs of the product.

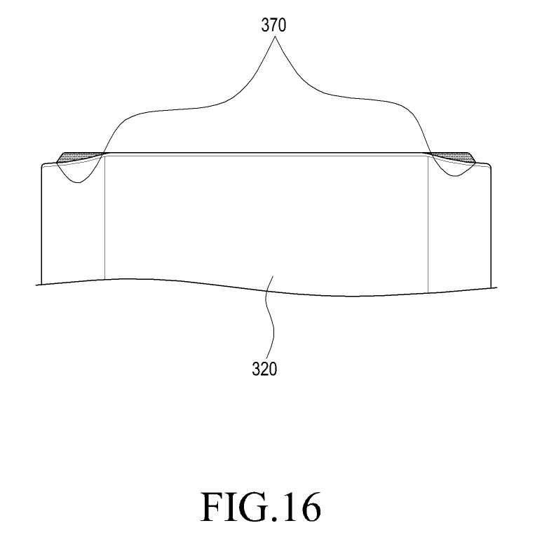

As in FIG. 16, an end of the insertion portion 321 of the shell part 320 may be formed with an inclined guide face 370 that guides the insertion portion 321 to be easily inserted into the shell part 320 of the electronic device 10. For example, by forming the inclined guide faces 370 by cutting opposite edges of the shell part 320, it is possible to the shell part 320 from being damaged or scratched by coming in contact with the outer portion of the socket 10b when the shell part 320 is inserted into the socket 10b of the electronic device 10. For example, the shell part 320 can be easily inserted into the socket 10b of the electronic device 10 by the inclined guide faces 370.

According to various embodiments of the present disclosure, as illustrated in FIG. 12 described above, a connector device may include: a housing part including a plurality of connectors that are built therein; a shell part coupled to the housing part to enclose the plurality of connectors; a plurality of wires electrically connected to the plurality of connectors; and a cap part coupled to the housing part. The housing part may be coupled to the cap part without a board, and may electrically connect the plurality of wires to the connectors by being pushed without the board.

According to various embodiments of the present disclosure, the shell part may be provided with a ground plate.

According to various embodiments of the present disclosure, the plurality of connectors may further include a ground terminal to be electrically connected to the ground plate and the wires.

According to various embodiments of the present disclosure, a first end of the shell part may be provided with an insertion portion to be inserted into a socket, and a second end, which is opposite to the first end, may be provided with a coupling portion to be coupled with a fastening portion provided on the housing part.

According to various embodiments of the present disclosure, an end of the insertion portion may further include an inclined guide face formed to guide insertion into the socket of the electronic device.

According to various embodiments of the present disclosure, the connector device may further include a shield can that is provided outside the housing part.

In the following, descriptions will be made with reference to a configuration of a male connector device 400 including a compact board 450 that is electrically coupled to the socket 10b of the external electronic device 10 according to various embodiments of the present disclosure.

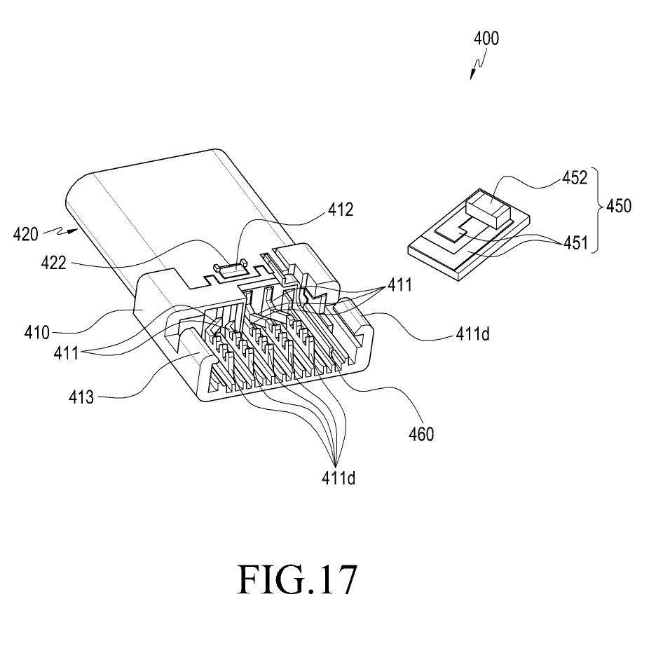

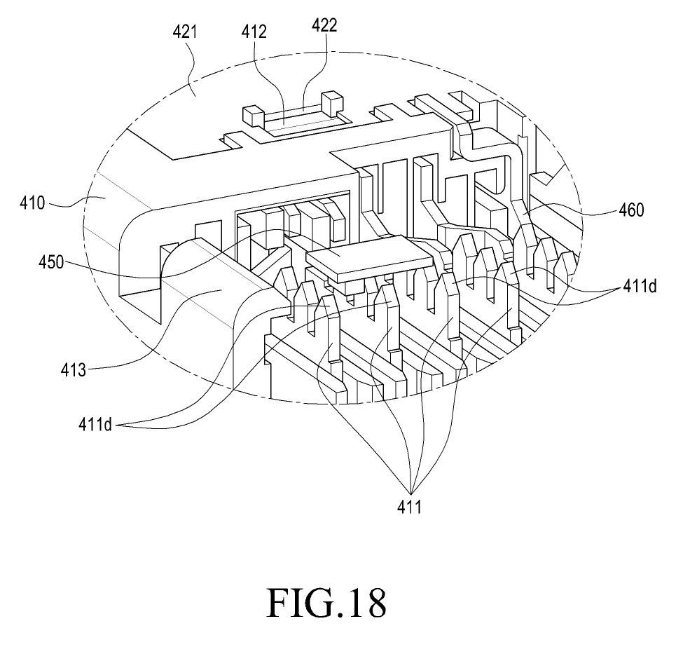

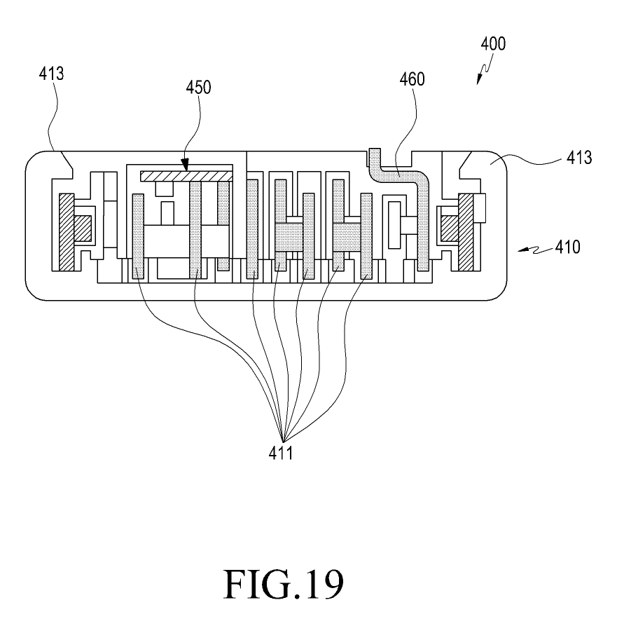

FIG. 17 illustrates an exploded perspective view of a configuration of a connector device 400 included in an electronic device according to various embodiments of the present disclosure, FIG. 18 illustrates a perspective view of a state in which a compact board 450 is coupled among the components of the connector device according to various embodiments of the present disclosure, and FIG. 19 illustrates a front view of the state in which the compact board 450 is coupled among the components of the connector device according to various embodiments of the present disclosure.

Referring to FIGS. 17 to 19, the connector device 400 may include, for example, a housing part 410 having a plurality of connectors 411 built therein, a shell part 420, a plurality of wires (not illustrated), a cap part (not illustrated), and a compact board 450.

The shell part 420 to be described later may be coupled to one face of the housing part 410, and the cap part (not illustrated) to be described later may be coupled to the side faces of the housing part 410.

A fastening portion may be formed on one face of the housing part 410 to be coupled with a coupling portion formed on the shell part 420.

Because a pair of hook portions 413 are provided on the side faces of the housing part 410 to be coupled to a pair of binding protrusions (not illustrated) formed on the cap part (not illustrated), the pair of binding protrusions of the cap part may be fitted and coupled to the pair of hook portions 413 when the cap part (not illustrated) is coupled to the upper portion of the housing part 310.

The shell part 420 is coupled to the housing part 410 so as to enclose as well as protect the connectors 411.

The plurality of wires (not illustrated) may be coupled to the cap part (not illustrated) to be electrically connected with the connectors 411.

The cap part (not illustrated) may be coupled to the housing part 410 so as to electrically connect the plurality of wires (not illustrated) and the connectors 411 to each other.

The board 450 may be inserted into the inside of the housing part 410 so as to electrically connect the connectors 411 and the plurality of wires to each other.

By providing the compact substrate 450 inside the housing part 410 so as to electrically connect the plurality of wires (not illustrated) and the connectors 411 as described above, it is possible to improve the electric connection between the plurality of wires (not illustrated) and the connectors 411, and to miniaturize and slim the product by providing the compact board 450 inside the housing part 410.

According to one embodiment, as illustrated in FIG. 17 described above, the shell part 420 may be provided with a ground plate. For example, the plurality of connectors 411 may be provided with a ground terminal 460 such that the ground plate and the plurality of wires (not illustrated) can be electrically connected to each other. For example, as illustrated in FIG. 18, because the housing part 410 includes the plurality of connectors 411 and the ground terminal 460 is separately provided at a position neighboring the plurality of connectors 411, the electric connection between the wires (not illustrated) and the connectors 411 can be further facilitated.

A configuration of the board 450 according to one embodiment will be described in more detail.

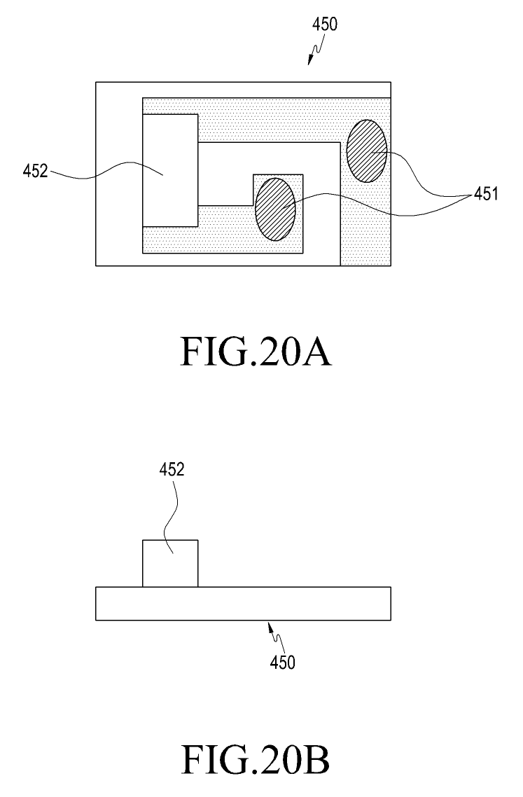

FIG. 20A illustrates a plan view of a board among the components of the connector device according to various embodiments of the present disclosure, and FIG. 20A illustrates a side view of the board 450 among the components of the connector device according to various embodiments of the present disclosure.

Referring to FIGS. 20A and 20B, the board 450 may include a plurality of connecting terminals 451 and a resistor 452. The plurality of connecting terminals 451 may be electrically connected to the plurality of connectors 411.

The resistor 452 may be provided at the position of the plurality of connecting terminals 451 so as to properly distribute a voltage to the connectors 411.

For example, when the resistor 452 is used with another component, an electric waveform may be converted into a proper form that is suitable for an electrical designer's request.

In addition, as illustrated in FIG. 17 described above, a first end of the shell part 420 may be provided with an insertion portion 421 to be inserted into the socket 10b of the electronic device 10. A second end of the shell part 420, which is opposite to the first end, may be provided with a coupling portion 422 to be coupled with a fastening portion 412 that is provided on the one face of the housing part 410.

For example, when the shell part 420 is coupled to the housing part 410, the coupling portion 422 of the shell part 420 may be fixedly hooked to the fastening portion 412 of the housing part 410 simultaneously when the coupling portion 422 of the shell part 420 is inserted into the fastening portion 412.

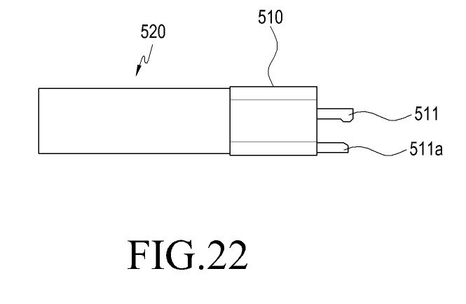

As illustrated in FIGS. 18 and 19 described above, the connector device 400 may include a housing part 410 having a plurality of connectors 411 built therein, a shell part 420, a plurality of wires (not illustrated), a cap part (not illustrated), and a compact board 450. The coupling portion of the shell part 420 is fixedly coupled to the fastening portion formed on one face of the housing part 410. Here, the housing part 410 is separately provided with a ground terminal 460 that is electrically connected to the ground plate that is built in the shell part 420 such that when the housing part 410 is coupled to the shell part 420, the ground terminal 460 is electrically connected to the ground plate. In this state, the plurality of wires (not illustrated) are coupled to the cap part (not illustrated), and the cap part (not illustrated) is coupled to the top face of the housing part 410. When the cap part (not illustrated) is strongly pushed to the housing part 410 side, the pair of binding protrusions formed on the cap part (not illustrated) are fixedly hooked to the pair of hook portions 413 formed on the top face of the housing part 410. Here, as in FIG. 22, the compact board 450 is coupled to the plurality of connectors 411 provided within the housing part 410, and at the same time, is electrically connected to the plurality of connectors 411 provided within the housing part 410. Further, the resistor 452 of the board 450 is inserted between the connectors 411. Due to this, the compact board 450 may be electrically connected to the plurality of connectors 411 simultaneously when being inserted into the inside of the housing. The plurality of wires (not illustrated) coupled to the cap part (not illustrated) are in contact with the connectors 411 built in the housing part 410, and the plurality of wires (not illustrated) are in contact with the wire terminals 411d provided in the remaining connectors 411 that are not electrically connected to the compact board 450, and at the same time, are covered with the wire terminals 411d such that the plurality of wires (not illustrated) and the connectors 411 are electrically connected to each other. For example, the wire terminals 411d penetrate the plurality of wires (not illustrated), thereby connecting the plurality of wires to the connectors. The wire terminals (not illustrated) are each formed in a triangular plate shape to easily cover the plurality of wires. According to one embodiment, when the cap part (not illustrated) with the plurality of wires (not illustrated) coupled thereto are pressed, the plurality of wires (not illustrated) are lowered such that the wire terminals 411d of the connectors 411 cover and penetrate the plurality of wires (not illustrated) to be coupled thereto, and at the same time, electrically connect the connectors 411 and the plurality of wires (not illustrated). Thereby, the assembly of the connector device 400 is completed. In addition, a separately provided ground wire (not illustrated) is electrically connected to the ground terminal 460.

In this state, the connectors 411 are inserted into the socket 10b of the electronic device 10 to be electrically connected thereto, and the electronic device 10 may be charged and may input and output data through the connectors 411.

In this way, because the separately provided ground terminal 460 prevents a short circuit, which may be generated between the connectors 411 and the shell part 420 by an inner voltage, it is possible to prevent a safety accident (e.g., a fire caused by the electric short circuit) and at the same time, to prevent a component of the electronic device 10 from being damaged.

In addition, by providing a compact board 450 within the housing part 410, the board 450 and the connectors 411 are electrically connected to each other, and electrically connecting the remaining connectors 411, which are not electrically connected to the board 450, directly to a plurality of wires (not illustrated), it is possible to further improve the electrical connection of the product, and to minimize the thickness of the housing part 410, thereby miniaturizing and slimming the product.

According to one embodiment, as described above with reference to FIGS. 17 and 18, for example, the connector device 400 may include a first connector 420 that is capable of being coupled to a receptacle (not illustrated) of a first external device 10, a second connector (not illustrated), a plurality of conductive wires (not illustrated) each including a first end electrically connected to the first connector 420 and a second end electrically connected to the second connector, and a cladding material that insulates the conductive wires.

The first connector 420 may include: a first structure 421 having a shape and a size that are capable of being coupled to the receptacle of the first external electronic device; a second structure 410 that is non-conductive and is connected to the first structure; a plurality of conductive connectors 411 each including a first end included within the first structure and a second portion included within the second structure 410; and a board 450 that includes a first face on which the plurality of conductive connectors 411 and the plurality of conductive wires (not illustrated) are electrically connected and a second face that faces in a direction opposite to the first face, the board 450 being built in the second structure.

The second structure 410 may include a first outer surface that faces in the same direction as the first face and a second outer surface that faces in the same direction as the second face, and when viewed from a side, the first face of the board 450 may be positioned between an imaginary surface, that is positioned in parallel with the first outer surface at a central location between the first outer surface and the second outer surface, and the second outer surface.

The first connector 420 may include a shell part, and the second connector may include the above-mentioned cap part. The first structure 421 may include the above-mentioned insertion part, and the second structure 410 may include the above-mentioned housing part.

According to various embodiments of the present disclosure, as illustrated in FIG. 17 described above, a connector device may include: a housing part including a plurality of connectors that are built therein; a shell part coupled to the housing part to enclose the plurality of connectors; a plurality of wires electrically connected to the plurality of connectors; a cap part coupled to the housing part; and a board that includes a resistor inserted into the housing part to be electrically connected to the plurality of connectors.

According to various embodiments of the present disclosure, the board may include: a plurality of connecting terminals that are electrically connected to the plurality of connectors; and a resistor provided at a position neighboring the plurality of connecting terminals.

According to various embodiments of the present disclosure, the shell part may be provided with a ground plate.

According to various embodiments of the present disclosure, the plurality of connectors may further include a ground terminal to be electrically connected to the ground plate and the wires.

In the following, descriptions will be made with reference to a configuration of a male connector device 500 including a board 560 that is electrically coupled to the socket 10b of the external electronic device 10 according to various embodiments of the present disclosure.

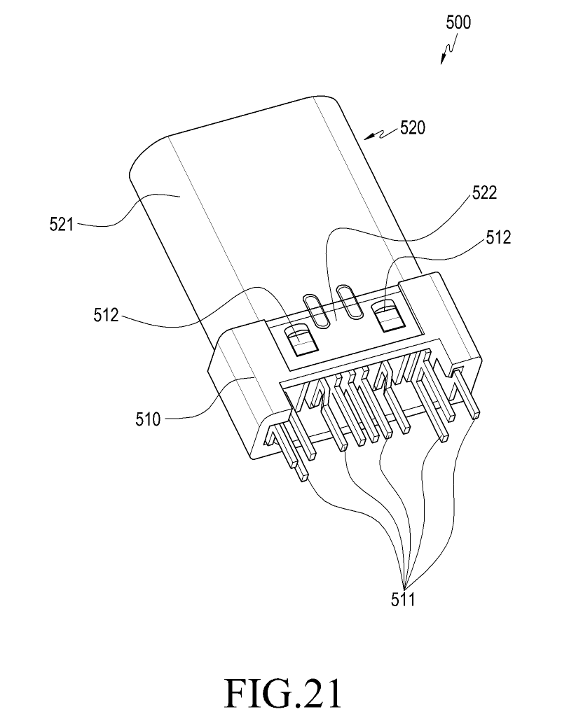

FIG. 21 illustrates a perspective view of a configuration of a connector device included in an electronic device according to various embodiments of the present disclosure, and FIG. 22 illustrates a side view of a configuration of a connector device according to various embodiments of the present disclosure.

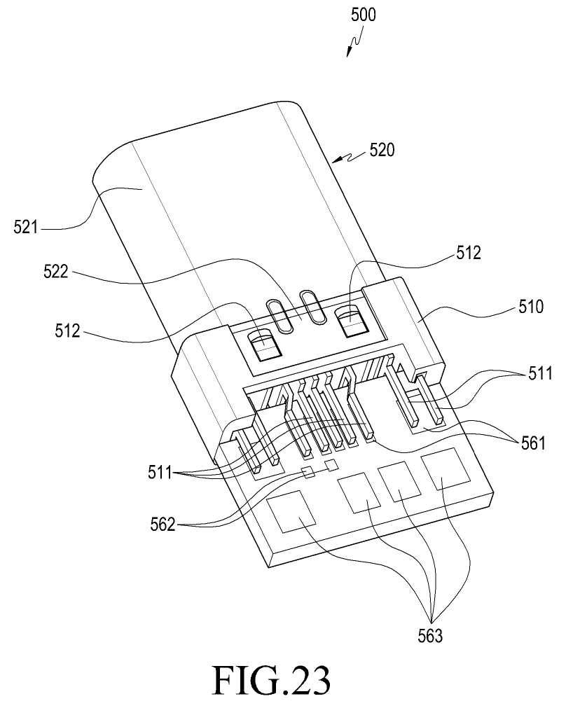

Referring to FIGS. 21 and 22, the connector device 500 may include, for example, a housing part 510 having a plurality of connectors 511 built therein, a shell part 520, a plurality of wires (not illustrated), a cap part (not illustrated), and a board 560 (see FIG. 23).

The shell part 520 to be described later may be coupled to one face of the housing part 510, and the cap part (not illustrated) to be described later may be coupled to the side faces of the housing part 510.

A fastening portion 512 may be formed on the one face of the housing part 510 to be coupled with a coupling portion 522 formed on the shell part 520.

The shell part 520 is coupled to the housing part 510 so as to enclose as well as protect the connectors 511 and 511a.

The plurality of wires (not illustrated) may be coupled to the cap part (not illustrated) to be electrically connected with the connectors 511 and 511a.

The connectors may include a first number of first connectors 511 and a second number of second connectors 511a.

The cap part (not illustrated) may be coupled to the housing part 510 so as to electrically connect the plurality of wires (not illustrated) and the connectors 511 to each other.

The board 560 (see FIG. 23) may be coupled to the housing part 510 such that the plurality of wires are fitted and coupled to the plurality of connectors 511 and at the same time, to be electrically connected to the plurality of connectors 511.

By providing the board 560 that is simultaneously coupled and electrically connected to the plurality of connectors 511 built in the housing part 510, it is possible to improve the electric connection between the cap part (not illustrated) and the connectors 511. For example, the plurality of connectors 511 may be formed as a pair of coupling terminals that are disposed on the top and bottom sides of the board 560, respectively.

A configuration of the board 560 according to one embodiment will be described in more detail.

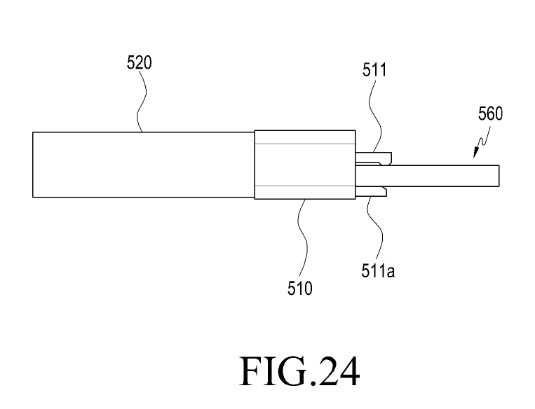

FIG. 23 illustrates a perspective view of a state in which the board 560 is coupled to the housing part 510 among the components of the connector device according to various embodiments of the present disclosure, and FIG. 24 illustrates a side view of the state in which the board 560 is coupled to the housing part 510 among the components of the connector device according to various embodiments of the present disclosure.

Referring to FIGS. 23 and 24, the board 560 may include a plurality of connecting terminals 561, a resistor 562, and a plurality of wire terminals 563. The plurality of connecting terminals 561 may be electrically connected to the plurality of connectors 511 and 511a.

The resistor 562 may be provided at the position of the plurality of connecting terminals 561 so as to properly distribute a voltage to the connectors 511 and 511a.

The plurality of wire terminals 563 may be provided on the board 560 to be electrically connected to the plurality of wires (not illustrated).

For example, when the resistor 562 is used with another component, an electric waveform may be converted into a proper form that is suitable for an electrical designer's request.

In addition, as illustrated in FIG. 23, a first end of the shell part 520 may be provided with an insertion portion 521 to be inserted into the socket 10b of the electronic device 10. A second end of the shell part 520, which is opposite to the first end, may be provided with a coupling portion 522 to be coupled with a fastening portion 512 that is provided on the one face of the housing part 510.

For example, when the shell part 520 is coupled to the housing part 510, the coupling portion 522 of the shell part 520 may be fixedly hooked to the fastening portion 512 of the housing part 510 simultaneously when the coupling portion 522 of the shell part 510 is inserted into the fastening portion 512.

As illustrated in FIGS. 23 and 24 described above, the connector device 500 may include a housing part 510 having a plurality of connectors 511 and 511a built therein, a shell part 520, a plurality of wires (not illustrated), a cap part (not illustrated), and a board 560. The coupling portion 522 of the shell part 520 is fixedly coupled to the fastening portion 512 formed on one face of the housing part 510. Here, the housing part 510 is separately provided with a ground terminal that is electrically connected to the ground plate (not illustrated) that is built in the shell part 520, and thus, when the housing part 510 is coupled to the shell part 520, the ground terminal (not illustrated) is electrically connected to the ground plate. In this state, the board 560 is fitted and coupled to a pair of connectors 511 and 511a provided in the housing part 510. Here, the board 560 is electrically connected to the housing part 510 by being fitted and coupled to the housing part 510. For example, because the board 560 is provided with a plurality of connecting terminals 561 that are electrically connected to the connectors 511 and 511a, when the board 560 is fitted and coupled to the pair of connectors 511 and 511a of the housing part 510, the plurality of connecting terminals 561 of the board 560 are electrically contacted and connected to the connectors 511 and 511a.

In this state, the plurality of wires (not illustrated) are electrically connected to the wire terminals 563 that are separately provided on the board 560, and the plurality of wires (not illustrated) are coupled to the top surface of the housing part 510.

In this state, the connectors 511 and 511a are inserted into the socket 10b of the electronic device 10 to be electrically connected thereto, and the electronic device 10 may be charged and may input and output data through the connectors 511 and 511a.

As described above, by providing the board 560 that is coupled to/released from the connectors 511 and 511a that are provided in the housing part 510 so as to perform an electrical connection/separation, the electrical connection between the board 560 and the connectors 511 and 511a can be improved, and a poor connection, which may occur between the connector device 500 and the socket 10b of the electronic device 10 when mounting/demounting the connector device 500, can be improved, which enables the reliability of the product to be improved while ensuring that the product can be used for a long time.

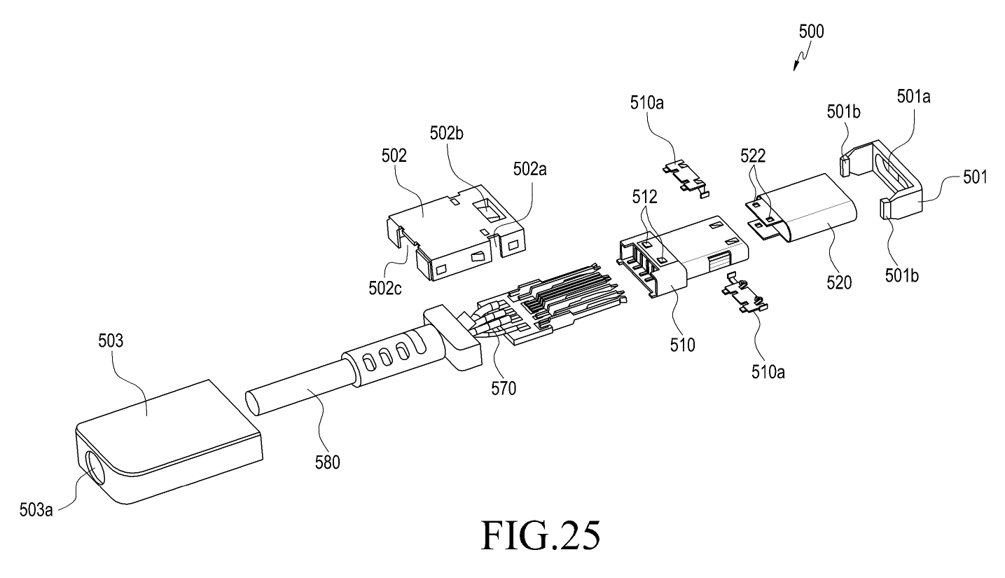

As illustrated in FIG. 25, the connector device 500 may include a housing part 510 having a plurality of connectors 211 built therein, a shell part 520, a plurality of wires 570, and a board 560. The connector device 500 may include first to third cover parts 501 to 503.

For example, the coupling portion 522 of the shell part 520 is fixedly coupled to the fastening portion 512 formed on one face of the housing part 510. Here, the housing part 510 is separately provided with a ground terminal 510a that is electrically connected to at least one ground plate (not illustrated) that is built in the shell part 520 such that when the housing part 510 is coupled to the shell part 520, the ground terminal 510a is electrically connected to the ground plate (not illustrated). In this state, the board 560 is fitted and coupled to a pair of connectors 511 and 511a provided in the housing part 510. Here, the board 560 is electrically connected to the connectors 511 and 511a of the housing part 510 by being fitted and coupled to the connectors 511 and 511a of the housing part 510. For example, because the board 560 is provided with a plurality of connecting terminals 561 that are electrically connected to the connectors 511 and 511a, when the board 560 is fitted and coupled to the pair of connectors 511 and 511a of the housing part 510, the plurality of connecting terminals 561 of the board 560 are electrically contacted and connected to the connectors 511 and 511a.

In this state, the plurality of wires 570 are electrically connected to the wire terminals 563 that are separately provided on the board 560, and the plurality of wires 570 are coupled to the top surface of the housing part 510.

The first cover part 501 may be coupled to the shell part 520, the second cover part 520 may be coupled to the housing part 510 and the board 560, and the third cover part 503 may be coupled to the first and second cover parts 501 and 502.

For example, the first cover part 501 may be formed with a through-hole 501a coupled to the shell part, and fastening members 501b may be provided at the opposite sides of the through-hole to be coupled to the coupling holes 502a formed in the second cover part 502.

The second cover part 502 may be coupled to protect the housing part 510 and the board 560, the first end of the second cover part 502 is connected to the first cover part 501, and the second end of the second cover part 502 may be coupled to the third cover part 503. On the side faces of the second cover part 502, coupling holes 502a may be formed to be coupled to the coupling members 501b of the first cover part 501. On the front face of the second cover part 502, a hook part 502b may be formed to be coupled to the coupling portion formed in the housing 510. On the rear face of the second cover part 502, a cable hole 502c may be formed to be coupled to a cable 580 connected to the plurality of wires 570. The third cover part 503 may be coupled to the first and second cover parts 501 and 502. The third cover part 503 may be formed with the through-hole 503a to be coupled to the cable 580 connected to the plurality of wires and passing therethrough. The second cover part 502 may be built in the third cover part 503, and the first cover part 501 may be coupled to one face of the third cover part 503.

Simultaneously when the shell part 520 is inserted into the socket 10b (see FIG. 1) of the electronic device 10 (see FIG. 1), the assembled connector device 500 may electrically connect the shell part 520 to the socket 10b via the connectors 511 and 511a provided in the housing, and the electronic device 10 may be charged and may input and output data.

By configuring the first to third cover parts 501 to 503 to be coupled to the shell part 520, the housing part 510, the board 560, and the cable 580 as described above, it is possible to protect the connector device 500 so as to prevent the connector device 500 from being damaged, thereby improving a poor electric connection between the connector device 500 and the socket 10b of the electronic device. Further, the product can be used for a long period, and the reliability of the product can be improved.

According to one embodiment, as described above with reference to FIGS. 23 and 24, the connector device 500 may include, for example, a first connector 520 that is capable of being coupled to a receptacle (not illustrated) of the first external device 10, a second connector (not illustrated), a plurality of conductive wires each including a first end electrically connected to the first connector and a second end electrically connected to the second connector (not illustrated), and a cladding material that insulates the conductive wires (not illustrated).

The first connector 520 may include: a first structure 521 having a shape and a size that are capable of being coupled to the receptacle of the first external electronic device 10, and including a first outer surface and a second outer surface that is symmetric to the first outer surface with respect to a first imaginary line and faces in a direction opposite to the first outer surface; and a first number of first connectors 511 included between the first outer surface and the first imaginary line; and a second number of second connectors 511a included between the first outer surface and the first imaginary line. The difference between the first number and the second number may be 0 to 5.

The first connector 520 may include a shell part, and the second connector may include the above-mentioned cap part. The first structure 521 may include the above-mentioned insert portion.

According to various embodiments of the present disclosure, as illustrated in FIG. 21 described above, a connector device may include: a housing part including a plurality of connectors that are built therein; a shell part coupled to the housing part to enclose the plurality of connectors; a plurality of wires electrically connected to the plurality of connectors; a cap part coupled to the housing part; and a board that includes a resistor coupled to the housing part and fitted and electrically coupled to the plurality of connectors to be electrically connected to the plurality of connectors.

According to various embodiments of the present disclosure, the board may include: a plurality of connecting terminals that are electrically connected to the plurality of connectors; a resistor provided at a position neighboring the plurality of connecting terminals; and a plurality of wire terminals electrically connected to the plurality of wires.

According to various embodiments of the present disclosure, the connectors may include a pair of coupling terminals to fit and couple the board thereto.

According to various embodiments of the present disclosure, the connector device may include: a first cover part coupled to the shell part; a second cover part coupled to the housing part and the board; and a third cover part coupled to the first and second cover parts.

According to various embodiments of the present disclosure, an electronic device may include: a first connector that is capable of being coupled to a receptacle of a first external electronic device; a second connector; a plurality of conductive wires each including a first end electrically connected to the first connector and a second end electrically connected to the second connector; and a cladding material that insulates the plurality of conductive wires.

The first connector may include: a first structure having a shape and a size that are capable of being coupled to the receptacle of the first external electronic device; a second structure that is non-conductive and is connected to the first structure; a first portion included within the first structure; and a plurality of conductive contacts, each of which includes a first portion included inside the first structure, and a second portion included inside the second structure; and a circuit structure that electrically connects two of the second portions of the plurality of conductive contacts to each other through a resistor element having a selected resistance value.

At least some of the plurality of conductive wires may be disposed to be in electric contact with a corresponding one of the plurality of conductive contacts without using solder.

According to various embodiments of the present disclosure, the second structure includes a space connected to the two of the second portions of the plurality of conductive contacts, and the circuit structure may be disposed within the space and may include an insulation material that is different from the second structure.

According to various embodiments of the present disclosure, the first connector may be compatible with USB C type standard, and the second connector may be compatible with USB 2.0 standard.

According to various embodiments of the present disclosure, an electronic device may include: a first connector that is capable of being coupled to a receptacle of a first external electronic device; a second connector; a plurality of conductive wires each including a first end electrically connected to the first connector and a second end electrically connected to the second connector; and a cladding material that insulates the plurality of conductive wires. The first connector may include: a first structure having a shape and a size that are capable of being coupled to the receptacle of the first external electronic device; a second structure that is non-conductive and is connected to the first structure; a plurality of conductive contacts, each of which includes a first portion included inside the first structure, and a second portion included inside the second structure; and a board that includes a first face on which the plurality of conductive contacts and the plurality of conductive wires are electrically connected and a second face that aces in a direction opposite to the first face, the board being built in the second structure.

The second structure may include a first outer surface that faces in the same direction as the first face and a second outer surface that faces in the same direction as the second face, and the first face of the board may be positioned between an imaginary surface positioned in parallel with the first outer surface at a central location between the first outer surface and the second outer surface and the second outer surface.

According to various embodiments of the present disclosure, at least some of the plurality of conductive wires may be disposed to be in electric contact with a corresponding one of the plurality of conductive contacts through solder.

According to various embodiments of the present disclosure, an electronic device may include: a first connector that is capable of being coupled to a receptacle of a first external electronic device; a second connector; a plurality of conductive wires each including a first end electrically connected to the first connector and a second end electrically connected to the second connector; and a cladding material that insulates the plurality of conductive wires.

The first connector may include: a first structure having a shape and a size that are capable of being coupled to the receptacle of the first external electronic device, and including a first outer surface and a second outer surface that is symmetric to the first outer surface with respect to a first imaginary line and faces in a direction opposite to the first outer surface; a first number of first contacts included between the first outer surface and the first imaginary line; and a second number of second contacts included between the first outer surface and the first imaginary line. The difference between the first number and the second number may be 0 to 5.

According to various embodiments of the present disclosure, the first connector may be compatible with USB C type standard, and the second connector may be compatible with USB 2.0 standard.

According to various embodiments of the present disclosure, the first number of contacts may include contacts that transfer CC, Vbus, and ground signals of USB 2.0 standard, and the second number of contacts may include contacts that transfer D+, D−, Vbus, and ground signals of USB 2.0 standard.

According to various embodiments of the present disclosure, an electronic device may include: a first connector that is capable of being coupled to a receptacle of a first external electronic device; a plurality of conductive wires electrically connected to the first connector; a cladding material that insulates the plurality of conductive wires; and a first structure having a shape and a size that are capable of being at least partially inserted into the receptacle of the first external electronic device. The first connector may include: a first conductive plate; a second conductive plate that faces in a direction opposite to the first conductive plate; and a polymer member that is substantially positioned within a space between the first conductive plate and the second conductive plate, and that is in contact with the first conductive plate or the second conductive plate. A part of the polymer member may protrude more than at least a portion of an edge of the first conductive plate or the second conductive plate toward the receptacle when viewed from above the first conductive plate or the second conductive plate.

According to various embodiments of the present disclosure, the first connector may include a shell part.

In the following, descriptions will be made with reference to a configuration of a male connector device 600 including a compact board 650 that is electrically coupled to the socket 10b of the external electronic device 10 according to still other various embodiments of the present disclosure.

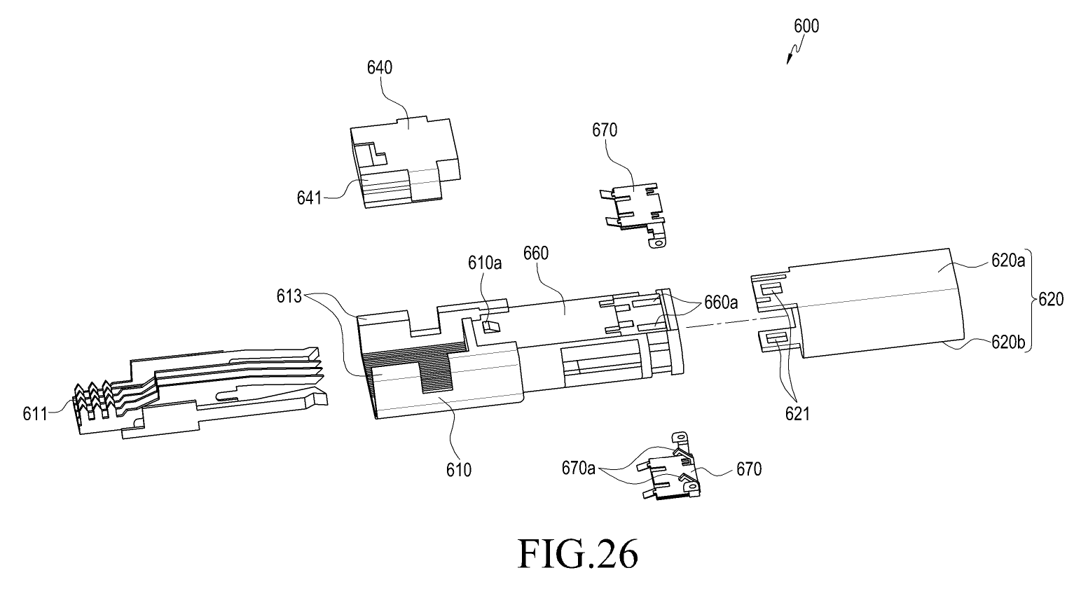

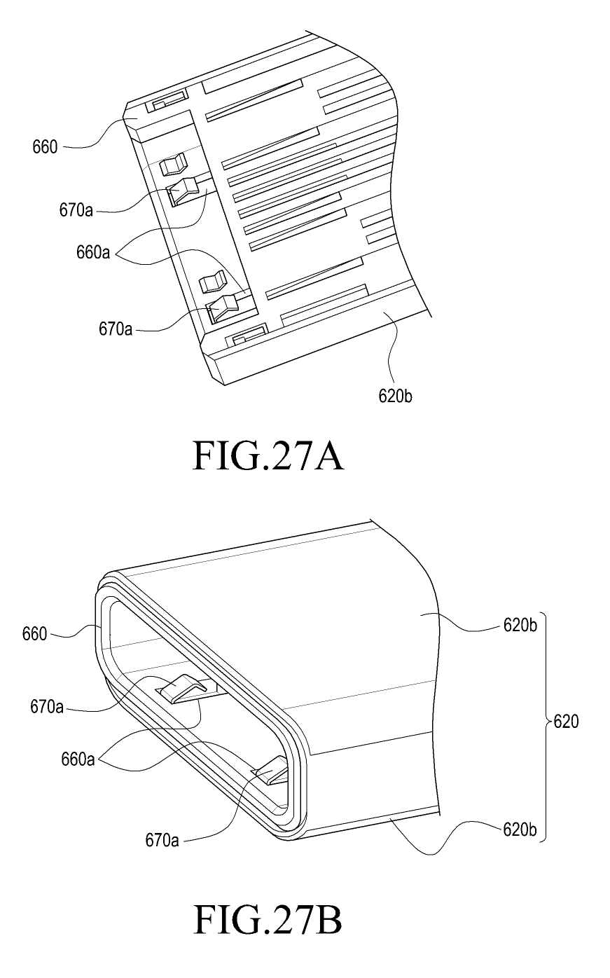

FIG. 26 illustrates a perspective view of a shell part among the components of the connector device according to still other various embodiments of the present disclosure, and FIGS. 27A and 27B illustrate enlarged perspective views of the shell part among the components of the connector device according to still other various embodiments of the present disclosure.

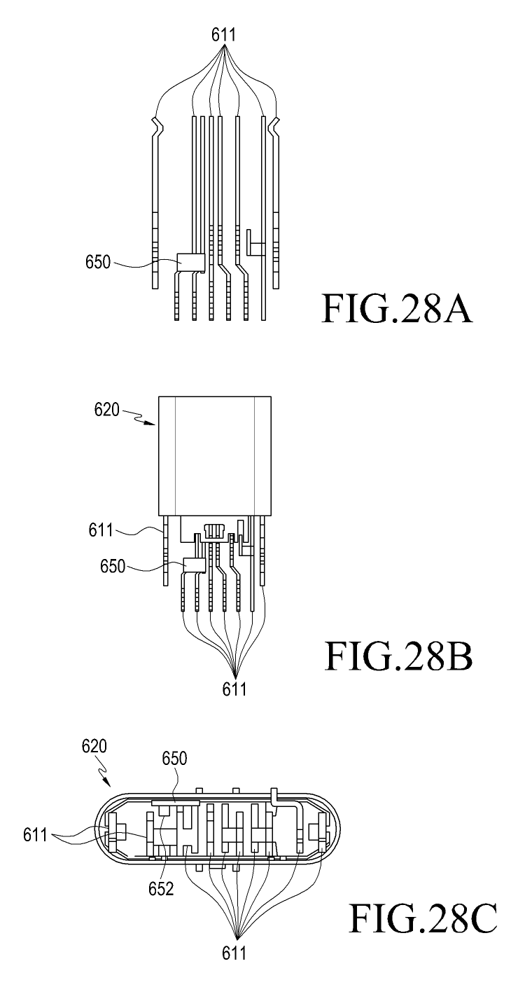

Referring to FIG. 26, the connector device 600 may include, for example, a housing part 610 having a plurality of connectors 611 built therein, a shell part 620, a plurality of wires (not illustrated), a cap part 640, and a compact board 650 (see FIG. 28A). The shell part 620 may include a conductive member, and the conductive member may include first and second conductive plates 620a and 620b.

One face of the housing part 610 may be provided with a coupling member 660, which may be coupled to the inside of the shell part 620. The shell part 620 may include the first and second conductive plates 620a and 620b to be coupled to the coupling member. For example, the coupling member 660 may be coupled to a space formed between the first and second conductive plates 620a and 620b. A cap part 640 to be described later may be coupled to the side face of the housing part 610. A fastening portion 610a may be formed on the one face of the housing part 610 to be coupled with a coupling portion 621 formed on the shell part 620. Because a pair of hook portions 613 are provided on the side faces of the housing part 610 to be coupled to a pair of binding protrusions 641 formed on the cap part 640, the pair of binding protrusions 641 of the cap part 640 may be fitted and coupled to the pair of hook portions 613 when the cap part 640 is coupled to the upper portion of the housing 610. The shell part 620 may be coupled to the coupling member 660 of the housing part 610 so as to enclose as well as protect the connectors 611. The plurality of wires (not illustrated) may be coupled to the cap part 640 to be electrically connected with the connectors 611. The cap part 640 may be coupled to the housing part 610 so as to electrically connect the plurality of wires (not illustrated) and the connectors 611 to each other.

The board 650 may be inserted into the inside of the housing part 610 to be electrically connected to the plurality of connectors 611.

According to one embodiment, as illustrated in FIGS. 27A and 27B, the second conductive plate 620b may be provided in a direction opposite to the first conductive plate 620a. The shell part 620 may be constituted with one conductive plate without being divided into the first and second conductive plates. For example, a space may be formed between the first conductive plate 620a and the second conductive plate 620b, and a coupling member 660 may be included in the space to be in contact with the first conductive plate 620a or the second conductive plate 620b.

As illustrated in FIG. 27B, a part of the coupling member 660 may be provided to protrude more than at least a portion of an edge of the first conductive plate 620a or the second conductive plate 620b toward the socket (not illustrated) of the electronic device 10 when viewed from above the first conductive plate 620a or the second conductive plate 620b. An end of the coupling member 660 may be coupled to protrude more than the first and second conductive plates 620a and 620b.

According to one embodiment, the first and second plates 620a and 620b may be configured by one conductive plate, the coupling member 660 is coupled to be in contact with the space formed in one conductive plate, and coupling member 660 may be provided to protrude more than the one conductive plate.

By configuring the coupling member 660 that protrudes more than one end of the first and second conductive plates 620a and 620b as described above, the first and second conductive plates 620a and 620b come in contact with the coupling member 660 first when the first and second conductive plates 620a and 620b are inserted into the socket (not illustrated) of the electronic device 10, which may prevent a poor electric connection of the first and second conductive plates 620a and 620b, thereby improving the reliability of the product.

By configuring the coupling member 660 that protrudes more than one end of the shell part 620 including the first and second conductive plates 620a and 620b, the coupling member 660 may come in contact with the shell part earlier than the coupling member 660, thereby preventing the shell part from being damaged.

According to one embodiment, the coupling member 660 may include a polymer member. The coupling member may include a conductive member and a non-conductive member.

According to one embodiment, as illustrated in FIG. 26 described above, the coupling member 660 may be formed to extend from the side face of the housing part 610, and at least one ground plate 670 may be provided on the outer face of the coupling member 660.

As illustrated in FIGS. 27A and 27B described above, at least one protrusion hole 660a may be formed in the coupling member 660 to cause a connection terminal 670a, which is provided on the at least one ground plate 670, to protrude therethrough. For example, the connection terminal 670a of the ground plate 670 protrudes through the protrusion hole 660a, and in this state, when the socket (not illustrated) of the electronic device 10 is coupled, the socket and the connection terminal 670a of the ground plate 670 can be electrically connected to each other.

A configuration of the board 650 according to one embodiment will be described in more detail.

FIG. 28A illustrates a plan view of a connector and a board among the components of the connector device 600 according to still other various embodiments of the present disclosure, FIG. 28B illustrates a plan view of a connector and a board included in the shell part among the components of the connector device according to still other various embodiments of the present disclosure, and FIG. 28C illustrates a side view of a connector and a board included in the shell part among the components of the connector device according to still other various embodiments of the present disclosure.

Referring to FIGS. 28A to 28C, a plurality of connectors 611 may be provided within the coupling member 660 to be electrically connected to the socket (not illustrated) of the electronic device 10.

As illustrated in FIG. 28C, because the board 650 is electrically connected to the plurality of connectors 611 and at this time, the board 650 includes a plurality of connecting terminals (not illustrated) and the resistor 652, the plurality of connecting terminals (not illustrated) may be electrically connected to the plurality of connectors 611. The resistor 652 may be provided at the position of the plurality of connecting terminals so as to properly distribute a voltage to the connectors 611.

For example, as illustrated in FIGS. 28B and 28C, the compact board 650 is simultaneously coupled and electrically connected to the plurality of connectors 611 provided within the housing part 610, and the resistor 652 of the board 650 is inserted between the connectors 611. Due to this, the compact board 650 may be simultaneously coupled to the shell part 620 and electrically connected to the plurality of connectors 611. The plurality of wires (not illustrated) coupled to the cap part 640 are in contact with the connectors 611 built in the housing part 610, and the plurality of wires (not illustrated) are in contact with the wire terminals 611d provided in the remaining connectors 611 that are not electrically connected to the compact board 650, and at the same time, are covered with the wire terminals 611d such that the plurality of wires (not illustrated) and the connectors 611 are electrically connected to each other. For example, the wire terminals 611d penetrate the plurality of wires (not illustrated), thereby connecting the plurality of wires to the connectors. The wire terminals (not illustrated) are each formed in a triangular plate shape to easily cover the plurality of wires. According to one embodiment, when the cap part (not illustrated) with the plurality of wires (not illustrated) coupled thereto are pressed, the plurality of wires (not illustrated) are lowered such that the wire terminals 611d of the connectors 611 cover and penetrate the plurality of wires (not illustrated) to be coupled thereto and simultaneously electrically connect the connectors 611 and the plurality of wires (not illustrated). Thereby, the assembly of the connector device 600 is completed.

In this state, the connectors 611 are inserted into the socket 10b of the electronic device 10 to be electrically connected thereto, and the electronic device 10 may be charged and may input and output data through the connectors 611.

According to one embodiment, by providing a compact board 650 within the housing part 610, the board 650 and the connectors 611 are electrically connected to each other, and electrically connecting the remaining connectors 611, which are not electrically connected to the board 650, directly to a plurality of wires (not illustrated), it is possible to further improve the electrical connection of the product, and to minimize the thickness of the housing part 610, thereby miniaturizing and slimming the product.

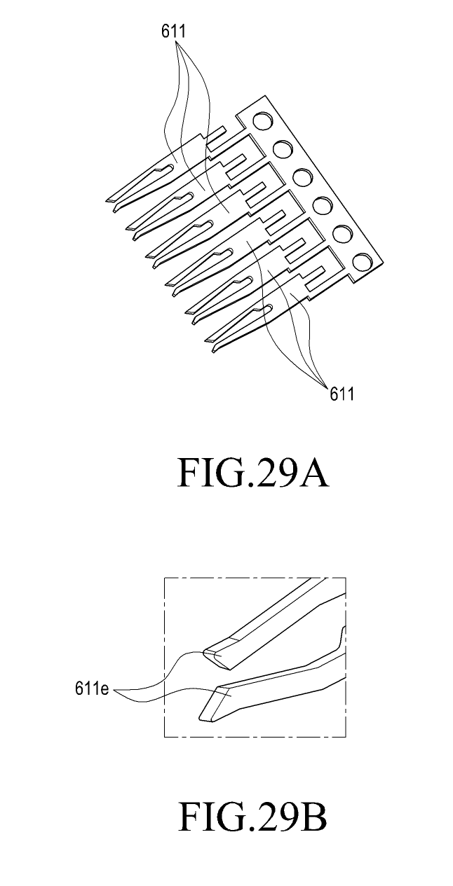

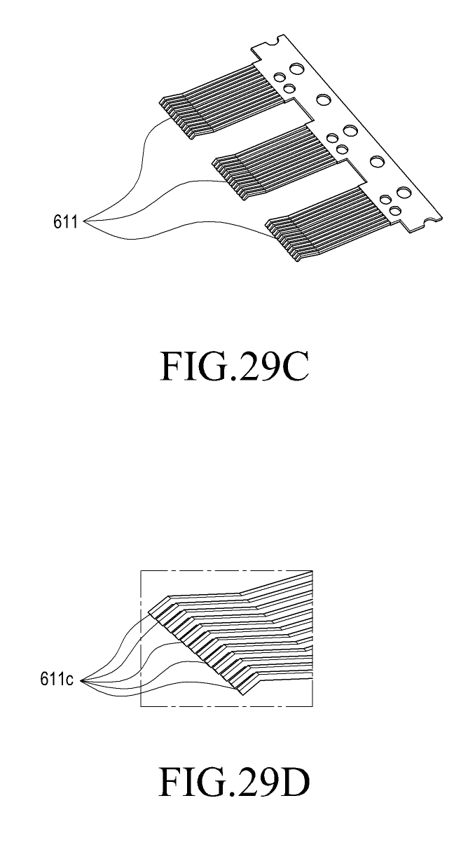

According to one embodiment, FIG. 29A illustrates a perspective view of a connector among the components of the connector device according to still other various embodiments of the present disclosure, and FIG. 29B illustrates an enlarged perspective view of a contact pin of a connector among the components of the connector device according to still other various embodiments of the present disclosure.

Referring to FIGS. 29A and 29B, the plurality of connectors 611 may include a pair of connection pins 611e to be electrically connected to the socket 10b of the electronic device 10. For example, when the terminal of the socket 10b is inserted between the pair of connection pins 611e to be electrically connected thereto, the connector 611 is in contact with the terminal of the socket 10b by the two connection pins such that the pair of connection pins 611e is capable of facilitating and maintaining the movement of a current and a voltage between the connector 611 and the socket 10b.

According to one embodiment, FIG. 29C illustrates a perspective view of another embodiment of a connector among the components of the connector device according to still other various embodiments of the present disclosure, and FIG. 29D illustrates an enlarged perspective view of another embodiment of a contact pin of a connector among the components of the connector device according to still other various embodiments of the present disclosure.

Referring to FIGS. 29C and 29D, each of the plurality of connectors 611 may include one connection pin 611c to be electrically connected to the socket 10b of the electronic device 10. For example, the one connection pin 611c is provided on one end of each connector 611. For example, when the terminal of the socket 10b is inserted between end portions of the one connection pin 611c to be electrically connected thereto, the one connector 611 may be in contact with the terminal of the socket 10b, thereby facilitating and maintaining the movement of a current and a voltage between the connector 611 and the socket 10b. On end of the connection pin 611c may be bent by a predetermined angle to be in contact with the socket.

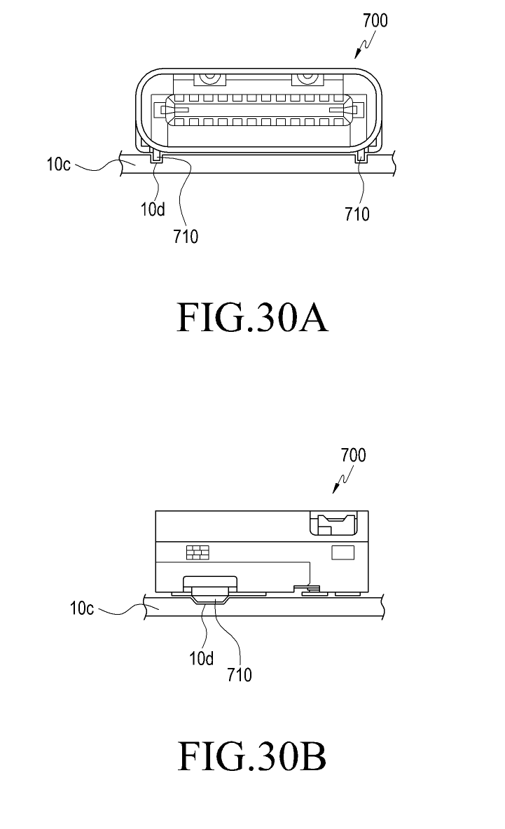

According to one embodiment, FIG. 30A illustrates a front view of a socket 700 of an electronic device, which is coupled to a connector device 600 (see FIG. 26) according to still other various embodiments of the present disclosure, and FIG. 30B illustrates a side view of the socket 700 of an electronic device, which is coupled to the connector device 600 (see FIG. 26) according to still other various embodiments of the present disclosure.

Referring to FIGS. 30A and 30B, the socket 700 may be provided with one or more fixing member 710 that protrude downward from the socket 700 to be fixed to a printed circuit board 10c provided in the electronic device 10 (see FIG. 1).

For example, the one or more fixing members 710 may be fixed by cutting the side face of the socket 700 and then unfolding the side face to protrude downward from the socket 700, and coupling and soldering the protruding fixing members 710 to a fixing hole 10d formed in the printed circuit board 10c.

In this state, even though the connector device 600 (see FIG. 26) is coupled to the socket 700, the socket 700 may be fixedly supported by the fixing members 710 of the socket 700.

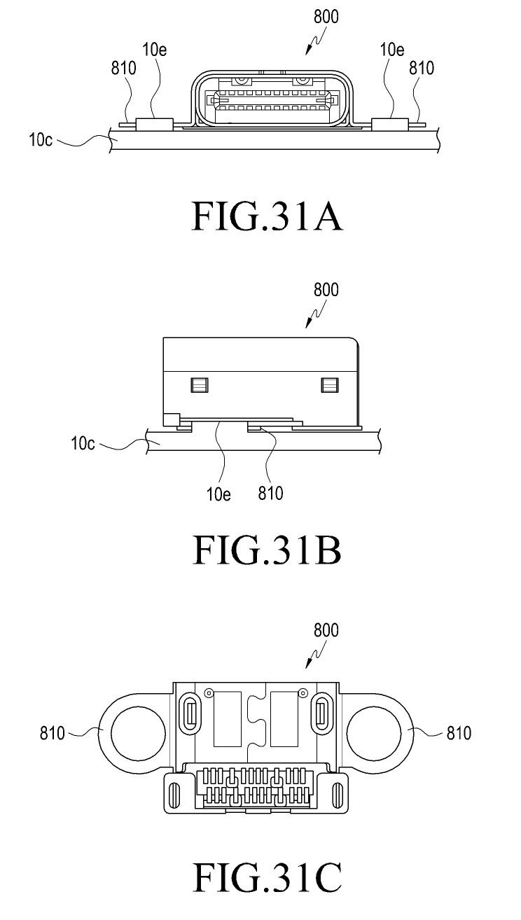

According to one embodiment, FIG. 30A illustrates a front view of another embodiment of a socket 800 of an electronic device, which is coupled to a connector device 600 (see FIG. 26) according to still other various embodiments of the present disclosure, FIG. 31B illustrates a side view of another embodiment of a socket of an electronic device, which is coupled to the connector device according to still other various embodiments of the present disclosure, and FIG. 31C illustrates a plan view of another embodiment of a socket of an electronic device, which is coupled to the connector device according to still other various embodiments of the present disclosure.

Referring to FIGS. 31A, 31B, and 31C, at least one circular fixing member 810 may be provided on a side face of the socket 800 to be coupled to at least one protrusion member 10e formed on the printed circuit board 10c provided in the electronic device, and at the same time, to be fixed thereto.

For example, the circular fixing members 810 may be coupled to protrusion members 10e of the print circuit board 10c and may be simultaneously fixed by soldering. The socket 800 may be fixed as the at least one fixing member 810 is coupled to at least one protrusion member 10e of the printed circuit board 10c.

In this state, when the connector device 600 (see FIG. 26) is coupled to the socket 800, the socket 800 may be fixedly supported by the at least one fixing members 810 of the socket 800 and the at least one protrusion member 10e.

According to various embodiments of the present disclosure, a connector device may include: a housing part including a plurality of connectors that are built therein; a shell part coupled to the housing part to enclose the plurality of connectors; a plurality of wires electrically connected to the plurality of connectors; a cap part coupled to the housing part; and a board that includes a resistor inserted into the housing part to be electrically connected to the plurality of connectors. The shell part may include a conductive member, and a coupling member that is substantially positioned within the conductive member, and is in contact with the conductive member. When viewing from above the conductive member, a portion of the coupling member protrudes more than at least a portion of an edge of the conductive member toward the socket of the electronic device.

According to various embodiments of the present disclosure, the conductive member may include first and second conductive plates in order to form a space in order to position the coupling member therein.

According to various embodiments of the present disclosure, the coupling member may include a polymer member.

According to various embodiments of the present disclosure, the coupling member may be formed to extend from a side face of the housing part, and at least one ground plate may be coupled to an outer face of the coupling member.

According to various embodiments of the present disclosure, at least one protrusion hole may be formed in the coupling member to cause a connection terminal, which is provided on at least one ground plate, to protrude therethrough.

According to various embodiments of the present disclosure, a plurality of connectors may be provided within the coupling member to be electrically connected to the socket of the electronic device.

According to various embodiments of the present disclosure, the plurality of connectors may include a pair of connection pins or one connection pin.

According to various embodiments of the present disclosure, the socket may be provided with at least one fixing member protruding downward from the socket and fixed to a printed circuit board provided in the electronic device.

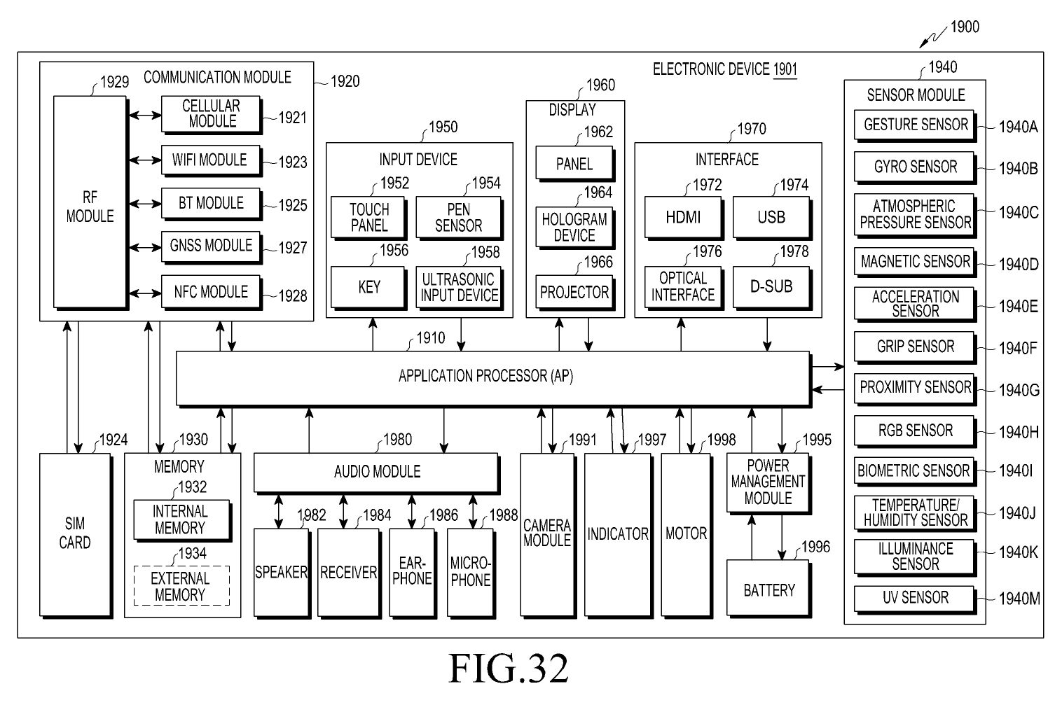

According to various embodiments of the present disclosure, the side face of the socket may be provided with at least one circular fixing member fixedly coupled to a protrusion member on the printed circuit board provided in the electronic device. FIG. 32 illustrates a block diagram of an electronic device 1901 according to various embodiments. The electronic device 1901 may include, for example, the whole or a portion of the electronic device 10 illustrated in FIG. 1. The electronic device 1901 may include at least one processor (e.g., an application processor (AP)) 1910, a communication module 1920, a subscriber identification module 1924, a memory 1930, a sensor module 1940, an input device 1950, a display 1960, an interface 1970, an audio module 1980, a camera module 1991, a power management module 1995, a battery 1996, an indicator 1997, and a motor 1998.

The processor 1910 may drive, for example, an operating system or an application program so as to control a plurality of hardware or software components connected thereto, and may also perform various data processing and arithmetic operations. The processor 1910 may be implemented by, for example, a system-on-chip (SoC). According to one embodiment, the processor 1910 may further include a graphic processing unit (GPU) and/or an image signal processor. The processor 1910 may include at least some components (e.g., a cellular module 1921) among the components illustrated in FIG. 19. The processor 1910 may load a command or data received from at least one of the other components (e.g., a non-volatile memory) in a volatile memory to process the command and data, and may store various data in a non-volatile memory.

The communication module 1920 may have a configuration that is the same as or similar to the communication interface 170 of FIG. 3. The communication module 1920 may include, for example, a cellular module 1921, a WiFi module 1923, a BLUETOOTH module 1925, a GNSS module 1927 (e.g., GPS module, GLONASS module, BEIDOU module, or GALILEO module), an NFC module 1928, and a radio frequency (RF) module 1929.

The cellular module 1921 may provide, for example, a voice call, a video call, a message service, or an internet service through a communication network. According to one embodiment, the cellular module 1921 may perform discrimination and authentication of the electronic device 1901 within the communication network by using the subscriber identification module (e.g., a SIM card) 1924. According to one embodiment, the cellular module 1921 may perform at least some of the multimedia control functions that may be provided by the processor 1910. According to one embodiment, the cellular module 1921 may include a communication processor (CP).

Each of the WiFi module 1923, the BLUETOOTH module 1925, the GNSS module 1927, and the NFC module 1928 may include, for example, a processor to process data transmitted or received through a corresponding module. According to a certain embodiment, at least some (e.g., two or more) of the cellular module 1921, the WiFi module 1923, the BLUETOOTH module 1925, the GNSS module 1927, and the NFC module 1928 may be incorporated in a single integrated chip (IC) or an IC package.

The RF module 1929 may transmit or receive a communication signal (e.g., an RF signal). The RF module 1929 may include, for example, a transceiver, a power amp module (PAM), a frequency filter, a low noise amplifier (LNA), or an antenna. According to another embodiment, at least one: of the cellular module 1921, the WiFi module 1923, the BLUETOOTH module 1925, the GNSS module 1927, or the NFC module 1928 may transmit or receive an RF signal through one or more separate RF modules.

The subscriber identification module 1924 may include, for example, a card that includes a subscriber identification module and/or an embedded SIM, and may also include intrinsic identification information (e.g., integrated circuit card identifier (ICCID)) or subscriber information (e.g., international mobile subscriber identity (IMSI)).

The memory 1930 (e.g., memory 130) may include, for example, an internal memory 1932 or an external memory 1934. The internal memory 1932 may include at least one of, for example, a volatile memory (e.g., Dynamic RAM (DRAM), static RAM (SRAM), or synchronous DRAM (SDRAM)), a non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash memory, or NOR flash memory), hard drive, or solid state drive (SSD)).

The external memory 1934 may further include a flash drive (e.g., compact flash (CF), secure digital (SD), micro secure digital (micro-SD), mini secure digital (mini-SD), extreme digital (xD), multi-media card (MMC), or memory stick). The external memory 1934 may be functionally and/or physically connected to the electronic device 1901 through various interfaces.

For example, the sensor module 1940 may measure a physical quantity or may sense an operating status of the electronic device 1901, and may then convert the measured or sensed information into electric signals. The sensor module 1940 may include at least one of, for example, a gesture sensor 1940A, a gyro sensor 1940B, an atmospheric pressure sensor 1940C, a magnetic sensor 1940D, an acceleration sensor 1940E, a grip sensor 1940F, a proximity sensor 1940G, a color sensor 1940H (e.g., RGB (red, green, blue) sensor), a biometric sensor 1940I, a temperature/humidity sensor 1940I, an illuminance sensor 1940K, and a ultra-violet (UV) sensor 1940M. Additionally or alternatively, the sensor module 1940 may include, for example, an E-nose sensor, an electromyography (EMG) sensor (not illustrated), an electroencephalogram (EEG) sensor, an electrocardiogram (ECG) sensor, an infra-red (IR) sensor, an iris sensor, and/or a fingerprint sensor. The sensor module 1940 may further include a control circuit for controlling one or more sensors incorporated therein. In a certain embodiment, the electronic device 1901 may further include a processor configured to control the sensor module 1940 as a part of the processor 1910 or separate from the processor 1910 so as to control the sensor module 1940 while the processor 1910 is in the sleep state.

The input device 1950 may include a touch panel 1952, a (digital) pen sensor 1954, a key 1956, or an ultrasonic input device 1958. As the touch panel 1952, at least one of, for example, a capacitive type touch panel, a resistive type touch panel, an infrared type touch panel, and an ultrasonic type panel may be used. Also, the touch panel 1952 may further include a control circuit. The touch panel 1952 may further include a tactile layer so as to provide a tactile reaction to the user.

The (digital) pen sensor 1954 may be, for example, a portion of the touch panel or may include a separate recognition sheet. The key 1956 may include, for example, a physical button, an optical key, or a keypad. The ultrasonic input device 1958 may sense, through a microphone (e.g., a microphone 1988), ultrasonic waves generated by an input tool so as to confirm data corresponding to the sensed ultrasonic waves.

The display 1960 (e.g., the display 160) may include a panel 1962, a hologram device 1964, or a projector 1966. The panel 1962 may include a configuration that is the same as or similar to that of the display 160 of FIG. 1. The panel 1962 may be implemented to be, for example, flexible, transparent, or wearable. The panel 1962 may be configured as a single module with the touch panel 1952. The hologram device 1964 may show a stereoscopic image in the air using interference of light. The projector 1966 may project light onto a screen so as to display an image. The screen may be located, for example, inside or outside the electronic device 1901. According to one embodiment, the display 1960 may further include a control circuit to control the panel 1962, the hologram device 1964, or the projector 1966.

The interface 1970 may include, for example, a high-definition multimedia interface (HDMI) 1972, a universal serial bus (USB) 1974, an optical interface 1976, or a D-subminiature (D-sub) 1978. For example, the interface 1970 may be included in the communication interface 170 illustrated in FIG. 3. Additionally or alternatively, the interface 1970 may include, for example, a mobile high-definition link (MHL) interface, a secure digital (SD) card/multi-media card (MMC) interface, or an infrared data association (IrDA) standard interface.

The audio module 1980 may bi-directionally convert, for example, sound and electric signals. At least some of the components of the audio module 1980 may be included in, for example, the input/output interface 150 illustrated in FIG. 1. The audio module 1980 may process sound information input or output through, for example, a speaker 1982, a receiver 1984, an earphone 1986, or a microphone 1988.

The camera module 1991 is a device that is capable of photographing, for example, a still image and a video image, and according to one embodiment, the camera module 1991 may include at least one image sensor (e.g., a front sensor or a rear sensor), a lens, an image signal processor (ISP), or a flash (e.g., LED or xenon lamp).

The power management module 1995 may manage, for example, the electric power of the electronic device 1901. According to one embodiment, the power management module 1995 may include a power management integrated circuit (PMIC), a charger integrated circuit (IC), or a battery or fuel gauge. The PMIC may be configured as a wired and/or wireless charge type. The wireless charging type may include, for example, a magnetic resonance type, a magnetic induction type, or an electromagnetic wave type, and may further include an additional circuit for wireless charging (e.g., a coil loop, a resonance circuit, or a rectifier). The battery gauge may measure the residual capacity of the battery 1996, and a voltage, a current, or a temperature during the charge. The battery 1996 may include, for example, a rechargeable battery and/or a solar battery.

The indicator 1997 may indicate a specific status of the electronic device 1901 or of a part thereof (e.g., AP 1910), such as a booting status, a message status, or a charged status. The motor 1998 may convert an electric signal into a mechanical vibration, and may generate, for example, a vibration or a haptic effect. Although not illustrated, the electronic device 1901 may include a processor (e.g., a GPU) to support a mobile TV. The processor to support a mobile TV may process media data according to the standard of, for example, digital multimedia broadcasting (DMB), digital video broadcasting (DVB), or MEDIAFLO™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

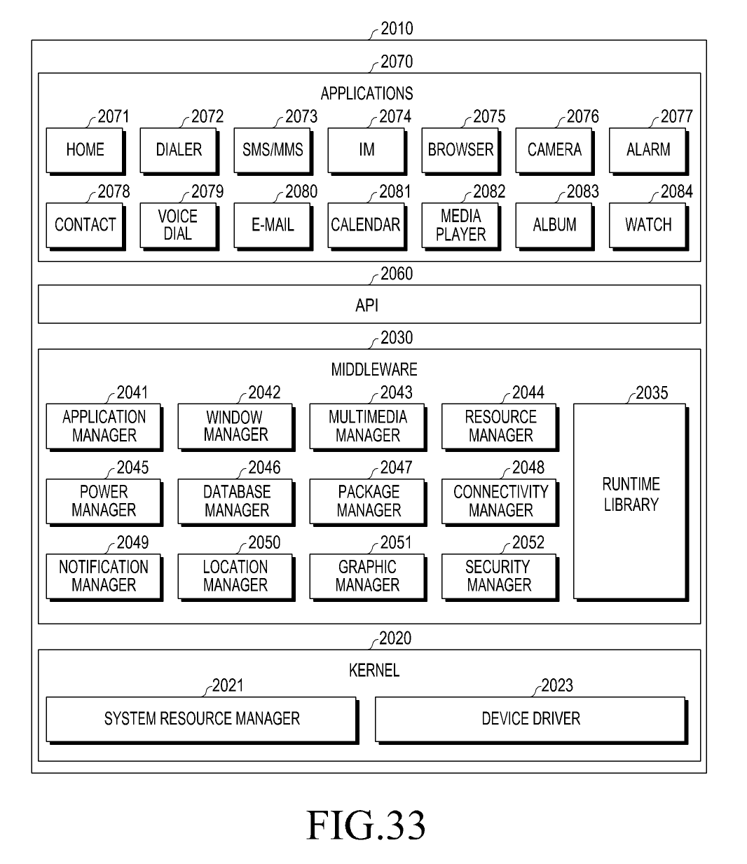

FIG. 33 illustrates a block diagram of a program module according to various embodiments. According to one embodiment, a program module 2010 (e.g., the program 140) may include an operating system (OS) that controls resources associated with an electronic device (e.g., the electronic device 10) and/or various applications (e.g., the application program 147) that are driven on the operating system. The operating system may be, for example, ANDROID, iOS, WINDOWS, SYMBIAN, TIZEN, or BADA.

The program module 2010 may include a kernel 2020, a middleware 2030, an application programming interface (API) 2060, and/or an application 2070. At least a part of the program module 2010 may be preloaded on the electronic device, or may be downloaded from an external electronic device (e.g., the device 102 or 104, or the server 106).

The kernel 2020 (e.g., the kernel 141) may include, for example, a system resource manager 2021 and/or a device driver 2023. The system resource manager 2021 may perform, for example, a control, allocation, or recovery of a system resource. According to one embodiment, the system resource manager 2021 may include, for example, a process management unit, a memory management unit, or a file system management unit. The device driver 2023 may include, for example, a display driver, a camera driver, a BLUETOOTH driver, a common memory driver, a USB driver, a keypad driver, a WiFi driver, an audio driver, or an inter-process communication (IPC) driver.

The middleware 2030 may provide, for example, a function that is commonly required by the applications 2070, or may provide various functions to the applications 2070 through the API 2060 such that the applications 2070 can efficiently use the limited system resources within the electronic device. According to one embodiment, the middleware 2030 (e.g., the middleware 143) may include at least one of a runtime library 2035, an application manager 2041, a window manager 2042, a multimedia manager 2043, a resource manager 2044, a power manager 2045, a database manager 2046, a package manager 2047, a connectivity manager 2048, a notification manager 2049, a location manager 2050, a graphic manager 2051, and a security manager 2052.

The runtime library 2035 may include, for example, a library module that is used by a compiler in order to add a new function through a program language while the applications 2070 are executed. The runtime library 2035 may perform, for example, input/output management, memory management, or a function for an arithmetic function.

The application manager 2041 may manage, for example, a life cycle of at least one application among the applications 2070. The window manager 2042 may manage a GUI resource that is used in a screen. The multimedia manager 2043 may grasp a format required for reproducing various media files, and may perform encoding or decoding of the media files by using a codec that is suitable for the corresponding format. The resource manager 2044 may manage a resource, such as a source code, a memory, or a storage space, of at least one application among the applications 2070.

The power manager 2045 is operated together with, for example, a basic input/output system (BIOS) so as to manage a battery or a power source, and may provide, for example, power information that is required for operating the electronic device. The database manager 2046 may generate, retrieve, or change a database to be used by at least one application among the applications 2070. The package manager 2047 may manage the installation or update of an application that is distributed in the form of a package file.

The connectivity manager 2048 may manage, for example, a wireless connection of WiFi, BLUETOOTH, or the like. The notification manager 2049 may display or notify events, such as an arrival message, appointment, and proximity notification in a manner that does not disturb the user. The location manager 2050 may manage position information of the electronic device. The graphic manager 2051 may manage a graphic effect to be provided to the user or a user interface associated therewith. The security manager 2052 may provide all security functions required for, for example, system security, or user authentication. According to one embodiment, in the case where the electronic device (e.g., the electronic device 10) includes a phone function, the middleware 2030 may include a telephony manager to manage a voice or video call function of the electronic device.

The middleware 2030 may include a middleware module that forms a combination of various functions of the above-described components. The middleware 2030 may provide a module that is specialized for each kind of operation system in order to provide differentiated functions. In addition, the middleware 2030 may dynamically delete some of the existing components or add new components.

The API 2060 (e.g., the API 145) is, for example, a collection of API programming functions, and may be provided in different configurations according to operation systems. For example, ANDROID or iOS may provide one API set for each platform and TIZEN may provide two or more API sets for each platform.

The applications 2070 (e.g., the application program 147) may include, for example, one or more applications that can execute, for example, the functions of home 2071, dialer 2072, SMS/MMS 2073, instant message (IM) 2074, browser 2075, camera 2076, alarm 2077, contact 2078, voice dial 2079, e-mail 2080, calendar 2081, media player 2082, album 2083, and watch 2084, health care (e.g., measurement of a quantity of motion, or blood sugar), or provision of environmental information (e.g., provision of atmospheric pressure, humidity, or temperature information).

According to one embodiment, the applications 2070 may include an application that supports information exchange between the electronic device (e.g., the electronic device 10) and the external electronic devices (e.g., the electronic devices 102 and 104) (hereinafter, the application will be referred to as an “information exchange application” for the convenience of description). The information exchange application may include, for example, a notification relay application to transmit specific information to the external electronic devices, or a device management application to manage the external electronic devices.

For example, the notification relay application may include a function of relaying notification information generated from any other application of the electronic device (e.g., an SMS/MMS application, an e-mail application, a healthcare application, or an environment information application) to the external electronic devices (e.g., the electronic devices 102 and 104). In addition, the notification relay application may receive notification information from, for example, an external electronic device, and may provide the notification information to the user.

The device management application may manage (e.g., install, delete, or update) at least one function of an external electronic device (e.g., the electronic device 102 or 104) that communicates with the electronic device (e.g., turn-on/turn-off of the external electronic device itself (or some components thereof) or adjustment of brightness (or resolution) of a display), an application operated in the external electronic device, or a service provided by the external electronic device (e.g., a telephony service or a message service).

According to one embodiment, the applications 2070 may include an application designated according to an attribute of an external electronic device (e.g., the electronic device 102 or 104) (e.g., a healthcare application of a mobile medical device). According to one embodiment, the applications 2070 may include an application received from an external electronic device (e.g., the server 106 or the electronic device 102 or 104). According to one embodiment, the applications 2070 may include a preloaded application or a third party application that is capable of being downloaded from the server. The names of the components of the program module 2010 according to the illustrated embodiment may vary depending on the kind of operation system.

According to various embodiments, at least a portion of the program module 2010 may be implemented by software, firmware, hardware, or a combination of two or more thereof. At least a portion of the program module 2010 may be implemented (e.g., executed) by, for example, a processor (e.g., the processor 120). At least a portion of the program module 2010 may include, for example, a module, a program, a routine, a set of instructions, or a process for performing one or more functions.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be a minimum unit of an integrated component element or a part thereof. The “module” may be a minimum unit for performing one or more functions or a part thereof. The “module” may be mechanically or electronically implemented. For example, the “module” according to the present disclosure may include at least one of an application-specific integrated circuit (ASIC) chip, a field-programmable gate arrays (FPGA), and a programmable-logic device for performing operations that has been known or are to be developed hereinafter.

According to various embodiments, at least some of the devices (for example, modules or functions thereof) or the method (for example, operations) according to the present disclosure may be implemented by a command stored in a computer-readable storage medium in a programming module form. The instruction, when executed by a processor (e.g., the processor 120), may cause the one or more processors to execute the function corresponding to the instruction. The computer-readable storage medium may be, for example, the memory 130.

The computer readable recoding medium may include a hard disk, a floppy disk, magnetic media (e.g., a magnetic tape), optical media (e.g., a Compact Disc Read Only Memory (CD-ROM) and a Digital Versatile Disc (DVD)), magneto-optical media (e.g., a floptical disk), a hardware device (e.g., a Read Only Memory (ROM), a Random Access Memory (RAM), a flash memory), and the like. In addition, the program instructions may include high class language codes, which can be executed in a computer by using an interpreter, as well as machine codes made by a compiler. The aforementioned hardware device may be configured to operate as one or more software modules in order to perform the operation of the present disclosure, and vice versa.

The programming module according to the present disclosure may include one or more of the aforementioned components or may further include other additional components, or some of the aforementioned components may be omitted. Operations executed by a module, a programming module, or other component elements according to various embodiments of the present disclosure may be executed sequentially, in parallel, repeatedly, or in a heuristic manner. Furthermore, some operations may be executed in a different order or may be omitted, or other operations may be added.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a first connector configured to couple to a receptacle of a first external electronic device;
a second connector;
a plurality of conductive wires each including a first end configured to electrically connect to the first connector and a second end configured to electrically connect to the second connector; and
a cladding material configured to insulate the plurality of conductive wires,
wherein the first connector includes:
a first structure comprising a shape and a size capable of coupling to the receptacle of the first external electronic device;
a second structure that is non-conductive and is connected to the first structure;
a plurality of conductive contacts, each of which includes a first portion included inside the first structure, and a second portion included inside the second structure; and
a circuit structure configured to electrically connect two of the second portions of the plurality of conductive contacts to each other through a resistor element having a selected resistance value, and
wherein at least some of the plurality of conductive wires are disposed to be in electric contact with a corresponding one of the plurality of conductive contacts without using a solder.

2. The electronic device of claim 1, wherein the second structure includes a space connected to the two of the second portions of the plurality of conductive contacts, and
the circuit structure is disposed within the space and includes an insulation material that is different from the second structure.

3. The electronic device of claim 1, wherein the first connector is compatible with USB C type standard, and
the second connector is compatible with USB 2.0 standard.

4. An electronic device comprising:
a first connector configured to couple to a receptacle of a first external electronic device;
a second connector;
a plurality of conductive wires each including a first end configured to electrically connect to the first connector and a second end configured to electrically connect to the second connector; and
a cladding material configured to insulate the plurality of conductive wires,
wherein the first connector includes:
a first structure comprising a shape and a size capable of coupling to the receptacle of the first external electronic device;
a second structure that is non-conductive and is connected to the first structure;
a plurality of conductive contacts, each of which includes a first portion included inside the first structure, and a second portion included inside the second structure; and
a board including a first face on which the plurality of conductive contacts and the plurality of conductive wires are electrically connected and a second face configured to face in a direction opposite to the first face, the board built in the second structure, and
wherein the second structure includes a first outer surface facing a same direction as the first face and a second outer surface facing the same direction as the second face, and
the first face of the board is positioned between an imaginary surface positioned in parallel with the first outer surface at a central location between the first outer surface and the second outer surface and the second outer surface.

5. The electronic device of claim 4, wherein at least some of the plurality of conductive wires are disposed to be in electric contact with a corresponding one of the plurality of conductive contacts through a solder.

6. An electronic device comprising:
a first connector configured to couple to a receptacle of a first external electronic device;
a second connector;
a plurality of conductive wires each including a first end configured to electrically connect to the first connector and a second end configured to electrically connect to the second connector; and
a cladding material configured to insulate the plurality of conductive wires,
wherein the first connector includes:
a first structure comprising a shape and a size capable of coupling to the receptacle of the first external electronic device, and including a first outer surface and a second outer surface that is symmetric to the first outer surface with respect to a first imaginary line and configured to face in a direction opposite to the first outer surface;
a first number of first contacts included between the first outer surface and the first imaginary line; and
a second number of second contacts included between the first outer surface and the first imaginary line, and
wherein a difference between the first number and the second number is from 0 to 5.

7. The electronic device of claim 6, wherein the first connector is compatible with USB C type standard, and
the second connector is compatible with USB 2.0 standard.

8. The electronic device of claim 7, wherein:
the first number of the first contacts include contacts that transfer CC, Vbus, and ground signals of USB 2.0 standard, and
the second number of the second contacts include contacts that transfer D⁺, D⁻, Vbus, and ground signals of USB 2.0 standard.

9. An electronic device comprising:
a first connector configured to couple to a receptacle of a first external electronic device;
a plurality of conductive wires configured to electrically connect to the first connector;
a cladding material configured to insulate the plurality of conductive wires; and
a first structure comprising a shape and a size configured to at least partially insert into the receptacle of the first external electronic device,
wherein the first connector includes:
a first conductive plate;
a second conductive plate configured to face in a direction opposite to the first conductive plate; and
a polymer member substantially positioned within a space between the first conductive plate and the second conductive plate and in contact with the first conductive plate or the second conductive plate, and
wherein a part of the polymer member is configured to protrude more than at least a portion of an edge of the first conductive plate or the second conductive plate toward the receptacle when viewed from above the first conductive plate or the second conductive plate.

10. A connector device included in an electronic device, the connector device comprising:
a housing part including a plurality of connectors that are built therein;
a shell part coupled to the housing part and configured to enclose the plurality of connectors;
a plurality of wires configured to electrically connect to the plurality of connectors; and
a cap part coupled to the housing part and configured to electrically connect the plurality of wires and the plurality of connectors,
wherein the shell part is provided with a plurality of contacts, two or more of the plurality of contacts are in contact with each of the connectors.

11. The connector device of claim 10, wherein;
each of the plurality of contacts is formed as dual contact portions, and
the dual contact portions include:
a first contact portion configured to electrically connect to a side face of each connector; and
a second contact portion configured to electrically connect to a contact terminal formed on each connector.

12. The connector device of claim 11, wherein the first contact portion is formed in a semi-spherical shape.

13. The connector device of claim 11, wherein each of the plurality of contacts is formed in a “U” shape.

14. The connector device of claim 10, wherein a first end of the shell part is provided with an insertion portion to be inserted into a socket, and a second end, which is opposite to the first end, is provided with a coupling portion to be coupled with a fastening portion provided on the housing part.

15. The connector device of claim 10, wherein each of the plurality of connectors includes a pair of connection pins configured to electrically connect to a socket of the electronic device.

16. The connector device of claim 10, wherein each of the plurality of connectors includes a pair of connection pins configured to electrically connect to a socket of the electronic device.

17. A connector device included in an electronic device, the connector device comprising:
a housing part including a plurality of connectors that are built therein;
a shell part coupled to the housing part and configured to enclose the plurality of connectors;
a plurality of wires configured to electrically connect to the plurality of connectors; and
a cap part coupled to the housing part,
wherein the housing part is coupled to the cap part without a board, and configured to electrically connect the plurality of wires to the connectors by being pushed without the board.

18. The connector device of claim 17, wherein the shell part is provided with a ground plate.

19. The connector device of claim 18, wherein the plurality of connectors further include a ground terminal configured to electrically connect to the ground plate and the wires.

20. The connector device of claim 18, wherein a first end of the shell part is provided with an insertion portion configured to insert into a socket, and a second end, which is opposite to the first end, is provided with a coupling portion configured to couple with a fastening portion provided on the housing part.

21. The connector device of claim 20, wherein an end of the insertion portion further includes an inclined guide face formed to guide insertion into the socket of the electronic device.

22. The connector device of claim 17, further including:
a shield can provided outside the housing part.

23. A connector device included in an electronic device, the connector device comprising:
a housing part including a plurality of connectors that are built therein;
a shell part coupled to the housing part and configured to enclose the plurality of connectors;
a plurality of wires configured to electrically connect to the plurality of connectors;
a cap part coupled to the housing part; and
a board including a resistor inserted into the housing part and configured to electrically connect to the plurality of connectors.

24. The connector device of claim 23, wherein the board includes:
a plurality of connecting terminals configured to electrically connect to the plurality of connectors; and
a resistor provided at a position neighboring the plurality of connecting terminals.

25. The connector device of claim 24, wherein the shell part is provided with a ground plate.

26. The connector device of claim 25, wherein the plurality of connectors further include a ground terminal configured to electrically connect to the ground plate and the wires.

27. A connector device included in an electronic device, the connector device comprising:
a housing part including a plurality of connectors that are built therein;
a shell part coupled to the housing part and configured to enclose the plurality of connectors;
a plurality of wires configured to electrically connect to the plurality of connectors;
a cap part coupled to the housing part; and
a board including a resistor coupled to the housing part and fitted and electrically coupled to the plurality of connectors configured to electrically connect to the plurality of connectors.

28. The connector device of claim 27, wherein the board includes:
a plurality of connecting terminals configured to electrically connect to the plurality of connectors;
a resistor provided at a position neighboring the plurality of connecting terminals; and
a plurality of wire terminals configured to electrically connect to the plurality of wires.

29. The connector device of claim 28, wherein the connectors include a pair of coupling terminals configured to fit and couple the board thereto.

30. The connector device of claim 28, further comprising:
a first cover part coupled to the shell part;
a second cover part coupled to the housing part and the board; and
a third cover part coupled to the first and second cover parts.

31. A connector device included in an electronic device, the connector device comprising:
a housing part including a plurality of connectors that are built therein;
a shell part coupled to the housing part and configured to enclose the plurality of connectors;
a plurality of wires configured to electrically connect to the plurality of connectors;
a cap part coupled to the housing part; and
a board including a resistor inserted into the housing part and configured to electrically connect to the plurality of connectors,
wherein the shell part includes:
a conductive member; and
a coupling member substantially positioned within the conductive member, and is in contact with the conductive member, and
wherein, when viewing from above the conductive member, a portion of the conductive member is configured to protrude more than at least a portion of an edge of the conductive member toward a socket of the electronic device.

32. The connector device of claim 31, wherein the conductive member includes first and second conductive plates in order to form a space in order to position the conductive member therein.

33. The connector device of claim 31, wherein the coupling member includes a polymer member.

34. The connector device of claim 31, wherein the coupling member is formed to extend from a side face of the housing part, and at least one ground plate is coupled to an outer face of the coupling member.

35. The connector device of claim 31, wherein at least one protrusion hole is formed in the coupling member that causes a connection terminal provided on at least one ground plate to protrude therethrough.

36. The connector device of claim 31, wherein a plurality of connectors are provided within the coupling member configured to electrically connect to the socket of the electronic device.

37. The connector device of claim 31, wherein the plurality of connectors includes a pair of connection pins or one connection pin.

38. The connector device of claim 31, wherein the socket is provided with at least one fixing member protruding downward from the socket and fixed to a printed circuit board provided in the electronic device.

39. The connector device of claim 31, wherein a side face of the socket is provided with at least one circular fixing member fixedly coupled to a protrusion member on a printed circuit board provided in the electronic device.
